(19) United States
(12) Patent Application Publication
(10) Pub. No.: US 2022/0169829 A1
(43) Pub. Date: Jun. 2, 2022

(54) COMPOSITIONS AND METHODS FOR PROTECTING ORGANIC POLYMERIC MATERIALS FROM THE DELETERIOUS EFFECTS OF EXPOSURE TO UV-C LIGHT

(71) Applicant: CYTEC INDUSTRIES INC., Princeton, NJ (US)

(72) Inventors: Jerry Mon-Hei ENG, Wilton, CT (US); Ram B. GUPTA, Stamford, CT (US); Xin LI, Stamford, CT (US); Jian-Yang CHO, Easton, CT (US); Kyle O'CONNOR, Stamford, CT (US); Thomas SANTAMARIA, Norwalk, CT (US); Min WANG, Darien, CT (US)

(73) Assignee: CYTEC INDUSTRIES INC., Princeton, NJ (US)

(21) Appl. No.: 17/535,089

(22) Filed: Nov. 24, 2021

Related U.S. Application Data
(60) Provisional application No. 63/190,443, filed on May 19, 2021.
(60) Provisional application No. 63/118,809, filed on Nov. 27, 2020.

(51) Int. Cl. C08K 5/00; C08L 23/06; C08L 23/12; C08K 5/132; C08K 5/529; C08K 5/3492; C08K 5/3435; C08K 5/3462

(52) U.S. Cl. CPC C08K 5/005; C08L 23/06; C08L 23/12; C08K 5/132; C08L 2201/08; C08K 5/3492; C08K 5/3435; C08K 5/3462; C08K 2201/019; C08K 5/529

(57) ABSTRACT

Polymer compositions for making stabilized polymeric articles that are resistant to at least one deleterious effect of discoloration, cracking, or crazing upon exposure to UV-C (190-280 nm) light are provided herein, wherein the polymer compositions include: (i) an organic polymeric material; and (ii) a stabilizer composition comprising: an antioxidant selected from the group consisting of hindered phenols, phosphites and phosphonites, and mixtures thereof; and a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVIN™ 770) alone. At least one of reduced discoloration, cracking, or crazing upon exposure to UV-C light is associated with the use of the light stabilizer in combination with the antioxidant compared to the antioxidant in the absence of the light stabilizer. Methods of stabilizing organic polymeric materials against the deleterious effects of UV-C light by adding to the organic polymeric materials the antioxidant and the light stabilizer, are also provided.

### RELATED APPLICATIONS

This application claims priority to U.S. Provisional Application Nos. 63/118,809 filed Nov. 27, 2020 (Docket No. CYT 2020-006-US-PSP), and 63/190,443 filed May 19, 2021 (Docket No. 2020-006-US-PSP2), each of which is incorporated herein by reference in its entirety. This application is also related in subject matter and ownership to U.S. Provisional Application Nos. 63/118,807 filed Nov. 27, 2020 (Docket No. CYT 2020-005-US-PSP), and 63/190,431 filed May 19, 2021 (Docket No. CYT 2020-005-US-PSP2).

### BACKGROUND OF THE TECHNOLOGY AND RELATED ART

### Field of the Technology

The present disclosure generally relates to protecting organic polymeric materials and stabilized polymeric articles made therefrom from the deleterious effects of exposure to UV-C (190-280 nm) light. The deleterious effects include discoloration, cracking, and/or crazing. More particularly, the present disclosure relates to stabilizer compositions having an antioxidant and a light stabilizer, wherein the stabilizer compositions are effective in reducing discoloration, cracking, or crazing of organic polymeric materials upon repeated or prolonged exposure to germicidal UV-C light.

### Description of the Related Art

Most polymeric organic materials undergo photodegradation when exposed to UV radiation, leading to irreversible chemical changes. These changes adversely affect the physical properties of the polymeric organic materials. Exposure to UV radiation is also detrimental to human skin, and leads to sunburn and skin cancer. Ultraviolet radiation ranges from 100 to 400 nm, and is classified in three sub-regions, viz., 100 to 280 nm (UV-C), 280 to 320 nm (UV-B) and 320 to 400 nm (UV-A). The primary source of UV radiation is sunlight. Solar radiation in the UV-C range does not reach Earth's surface as it gets absorbed by the ozone layer of the stratosphere and by oxygen in the layers above. Thus, immense efforts have been made over the past more than 60 years to develop stabilizers to protect organic polymeric materials and human skin from the deleterious effects of UV-B and UV-A radiation. It is no surprise though that stabilization against UV-C light has largely been ignored, because it was never an issue. However, with the spread of the novel coronavirus COVID-19 the world over, scientists have been endeavoring to reduce transmission in various ways, including disinfecting various objects or belongings with UV-C radiation, which is germicidal. Within a short period of time there has been an exponential growth in utilization of UV-C light irradiation as a disinfectant tool, mainly for indoor applications. Various UV-C devices are being fabricated and used for indoor applications, e.g., for disinfection in medical buildings/hospitals; various modes of transportation, such as, airplanes, trains, automobiles, buses (including stations and airports); commercial and residential interiors including retail stores, restaurants, bars; indoor equipment including furniture, paints, personal protective equipment (PPE), carpets and textiles, and electrical and electronic devices, etc.

The preferred UV-C wavelength range for disinfection is considered to be between 200 to 280 nm, and the especially preferred range is 222 to 254 nm. It has been demonstrated that UV-C exposure effectively and efficiently inactivates microorganisms, including the COVID-19 virus. However, there appears to be a lack of deeper understanding of what adverse effects UV-C exposure has on organic polymeric materials or articles manufactured with these materials. The polymeric organic materials used for indoor applications and manufactured articles do not normally require stabilizers to protect against UV-A and UV-B radiation, because of the limited exposure to UV-A and UV-B from sunlight indoors. Instead, polymeric organic materials used for indoor articles routinely use processing additives, especially antioxidants, e.g., organic phosphites and hindered phenols, to prevent degradation and color generation during exposure to the high temperatures required for processing and formation of the manufactured polymeric articles. However, with the indoor use of UV-C germicidal light, it is important to address whether the polymeric articles made from organic polymeric materials and antioxidants used for processing will have any deleterious effects from UV-C exposure. Particularly concerning is the fact that UV-C radiation is of higher energy than UV-A and UV-B, and may be more harmful to the organic polymeric material. There is also a lack of understanding of UV-C exposure stability and what effect UV-C exposure has on the antioxidants used to protect polymeric organic materials themselves against UV-A and UV-B light.

While CN 111 286 116 discloses a UV-C irradiation-resistant polypropylene/polyethylene weather-resistant composite material, it is composed of numerous raw materials that unnecessarily add to the cost of the solution and, thus, do not make it practical for widespread industrial use amongst varied applications.

CN 112 778 730 relates to a UV-C radiation-resistant polycarbonate composition that includes polycarbonate, SAN, ASA rubber powder, a triazine UV absorber, benzotriazole, hindered amine light stabilizer (HALS), phosphites and thiodipropionates, and metal deactivators, amongst other processing aids.

Thus, there is an urgent need for stabilizer compositions to protect polymeric organic materials, as well as articles of manufacture made therefrom, from exposure to UV-C radiation. In particular, there is a need for stabilizer compositions that reduce discoloration, cracking, and/or crazing of organic polymeric materials upon exposure to UV-C light. Such stabilizer compositions would be a useful advance in the art and could find rapid acceptance by industry.

### SUMMARY OF THE DISCLOSURE

The present disclosure provides polymer compositions for making stabilized polymeric articles that are resistant to at least one of discoloration, cracking, and/or crazing upon repeated or prolonged exposure to UV-C (190-280 nm) light, wherein the polymer compositions include, but are not limited to: (i) an organic polymeric material; and (ii) a stabilizer composition having: an antioxidant selected from the group consisting of hindered phenols, phosphites and phosphonites, and mixtures thereof; and a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVIN™ 770) alone. At least one of reduced discoloration, cracking, and/or crazing upon exposure to UV-C light is associated with the use of the light stabilizer in combination with the antioxidant compared to the antioxidant in the absence of the light stabilizer.

The instant disclosure also provides stabilized polymeric articles resistant to discoloration, cracking, or crazing upon exposure to UV-C (190-280 nm) light, wherein the polymeric articles include the polymer compositions as described herein. At least one of reduced discoloration, cracking, and/or crazing upon repeated or prolonged exposure to UV-C light is associated with the use of the light stabilizer in combination with the antioxidant, even where barium compounds (such as barium salts) are absent from the stabilizer composition, compared to the antioxidant in the absence of the light stabilizer.

Further provided are methods of stabilizing an organic polymeric material against the deleterious effects of UV-C (190-280 nm) light, the method including adding to an organic polymeric material a stabilizer composition as described herein. At least one of reduced discoloration, cracking, and/or crazing upon exposure to UV-C light is associated with the use of the light stabilizer in combination with the antioxidant, even where barium compounds (such as barium salts) are absent from the stabilizer composition, compared to the antioxidant in the absence of the light stabilizer.

Methods of making stabilized polymeric articles are also provided, wherein such methods include: adding to an organic polymeric material a stabilizer composition having an antioxidant and a light stabilizer, even where barium compounds (such as barium salts) are absent from the stabilizer composition, and shaping the organic polymeric material containing the stabilizer composition into the stabilized polymeric article.

This summary may not list all characteristics or elements, and subcombinations of elements may also constitute an invention. These and other objects, features, and advantages of the invention will become apparent from the following detailed description taken in conjunction with the accompanying Examples and Drawings.

### BRIEF DESCRIPTION OF THE DRAWINGS

FIG. 1A is a microscope photo of the unstabilized polypropylene plaque of Ex. 5, Sample 6-1, after being exposed to UV-C irradiation for 250 hours showing significant surface cracking and/or crazing.

FIG. 1B is a microscope photo of the polypropylene plaque of Ex. 5, Sample 6-2, containing 0.08% CYANOXTM 2777 after being exposed to UV-C irradiation for 250 hours. It shows some surface cracking and/or crazing, but less than Sample 6-1.

FIG. 1C is a microscope photo of the polypropylene plaque of Ex. 5, Sample 6-4, containing 0.08% IRGANOX™ 1076 after being exposed to UV-C irradiation for 250 hours. It shows very little surface cracking and/or crazing.

### DETAILED DESCRIPTION OF THE DISCLOSURE

The present inventors have discovered that stabilizer compositions including, but not limited to, both antioxidants and light stabilizers are particularly useful to make polymeric articles resistant to the deleterious effects of repeated or prolonged exposure to UV-C light. The antioxidant is selected from the group consisting of hindered phenols, phosphites and phosphonites, and mixtures thereof; and the light stabilizer is selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVINTM 770) alone. Advantageously, at least one of reduced discoloration, cracking, and/or crazing upon exposure to UV-C light is associated with the use of the light stabilizer in combination with the antioxidant compared to the antioxidant in the absence of the light stabilizer.

### Definitions

As employed herein, the following terms are provided to assist the reader. Unless otherwise defined, all terms of art, notations and other scientific terminology used herein are intended to have the meanings commonly understood by those of skill in the chemical arts.

Throughout this specification the terms and substituents retain their definitions. A comprehensive list of abbreviations utilized by organic chemists (i.e., persons of ordinary skill in the art) appears in the first issue of each volume of the Journal of Organic Chemistry. The list, which is typically presented in a table entitled “Standard List of Abbreviations” is incorporated herein by reference.

The term “hydrocarbyl” is a generic term encompassing aliphatic, alicyclic and aromatic groups having an all-carbon backbone and consisting of carbon and hydrogen atoms, except where otherwise stated. In certain cases, as defined herein, one or more of the carbon atoms making up the carbon backbone may be replaced by a specified atom or group of atoms. Examples of hydrocarbyl groups include alkyl, cycloalkyl, cycloalkenyl, carbocyclic aryl, alkenyl, alkynyl, alkylcycloalkyl, cycloalkylalkyl, cycloalkenylalkyl, and carbocyclic aralkyl, alkaryl, aralkenyl and aralkynyl groups. Such groups can be optionally substituted by one or more substituents as defined herein. Accordingly, the chemical groups or moieties discussed in the specification and claims should be understood to include the substituted or unsubstituted forms. The examples and preferences expressed below apply to each of the hydrocarbyl substituent groups or hydrocarbyl-containing substituent groups referred to in the various definitions of substituents for compounds of the formulas described herein unless the context indicates otherwise.

Preferred non-aromatic hydrocarbyl groups are saturated groups such as alkyl and cycloalkyl groups. Generally, and by way of example, the hydrocarbyl groups can have up to fifty carbon atoms, unless the context requires otherwise. Hydrocarbyl groups with from 1 to 30 carbon atoms are preferred. Within the sub-set of hydrocarbyl groups having 1 to 30 carbon atoms, particular examples are C₁₋₂₀ hydrocarbyl groups, such as C₁₋₁₂ hydrocarbyl groups (e.g., C₁₋₆ hydrocarbyl groups or C₁₋₄ hydrocarbyl groups), specific examples being any individual value or combination of values selected from C₁ through C₃₀ hydrocarbyl groups.

Alkyl is intended to include linear, branched, or cyclic hydrocarbon structures and combinations thereof. Lower alkyl refers to alkyl groups of from 1 to 6 carbon atoms, preferably from 1 to 4 carbon atoms. Examples of lower alkyl groups include methyl, ethyl, propyl, isopropyl, butyl, s-and t-butyl, pentyl, hexyl, or cyclohexyl and the like. Preferred alkyl groups are those of C₃₀ or below.

Alkoxy or alkoxyalkyl refers to groups of from 1 to 20 carbon atoms of a straight, branched, cyclic configuration and combinations thereof attached to the parent structure through an oxygen. Examples include methoxy, ethoxy, propoxy, isopropoxy, cyclopropyloxy, cyclohexyloxy and the like.

Acyl refers to formyl and to groups of 1, 2, 3, 4, 5, 6, 7, 8, 9, 10, 11 and 12 carbon atoms of a straight, branched, cyclic configuration, saturated, unsaturated and aromatic and combinations thereof, attached to the parent structure through a carbonyl functionality. Examples include acetyl, benzoyl, propionyl, isobutyryl, tert-butoxycarbonyl, benzyloxycarbonyl and the like. Lower acyl refers to acyl groups containing one to six carbons.

References to “carbocyclic” or “cycloalkyl” groups as used herein shall include both aromatic and non-aromatic ring systems, unless the context indicates otherwise. Thus, for example, the term includes within its scope aromatic, non-aromatic, unsaturated, partially saturated and fully saturated carbocyclic ring systems. In general, such groups may be monocyclic or bicyclic and may contain, for example, 3 to 12 ring members, more usually 5 to 10 ring members. Examples of monocyclic groups are groups containing 3, 4, 5, 6, 7, and 8 ring members, more usually 3 to 7, and preferably 5 or 6 ring members. Examples of bicyclic groups are those containing 8, 9, 10, 11 and 12 ring members, and more usually 9 or 10 ring members. Examples of non-aromatic carbocycle/cycloalkyl groups include c-propyl, c-butyl, c-pentyl, c-hexyl, and the like. Examples of C₇ to C₁₀ polycyclic hydrocarbons include ring systems such as norbornyl and adamantyl.

Aryl (carbocyclic aryl) refers to a 5- or 6-membered aromatic carbocycle ring containing; a bicyclic 9- or 10-membered aromatic ring system; or a tricyclic 13- or 14-membered aromatic ring system. The aromatic 6- to 14-membered carbocyclic rings include, e.g., substituted or unsubstituted phenyl groups, benzene, naphthalene, indane, tetralin, and fluorene.

Substituted hydrocarbyl, alkyl, aryl, cycloalkyl, alkoxy, etc. refer to the specific substituent wherein up to three H atoms in each residue are replaced with alkyl, halogen, haloalkyl, hydroxy, alkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, halobenzyl, heteroaryl, phenoxy, benzyloxy, heteroaryloxy, benzoyl, halobenzoyl, or lower alkylhydroxy.

The term “halogen” means fluorine, chlorine, bromine or iodine.

The term “polymer,” “polymeric material,” or “polymeric composition” as used throughout the description and claims of the application refers to any combination of monomer units but explicitly excludes polycarbonate and polychloroprene latex compositions.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

As used herein and in the appended claims, singular forms include plural referents unless the context clearly dictates otherwise. For example, the terms “a” and “an” and “the” as used herein do not denote a limitation of quantity and are to be construed to cover both the singular and the plural, unless otherwise indicated herein or clearly contradicted by context.

For purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group including any two or more of the explicitly listed elements, components, or features. Additionally, any element, component, or feature recited in such a list may also be omitted from such list. Any optional component of the polymer composition, stabilized polymeric article, or method of reducing discoloration can be expressly excluded.

“At least one of” as used herein in connection with a list means that the list is inclusive of each element individually, as well as combinations of two or more elements of the list, and combinations of at least one element of the list with like elements not named.

Those skilled in the art will further understand that any recitation herein of a numerical range by endpoints includes all numbers subsumed within the recited range (including fractions), whether explicitly recited or not, as well as the endpoints of the range and equivalents. Thus, description of (1 to 5, for example, includes 1, 2, 3, 4, and 5 when referring to, for example, a number of elements, and can also include 1.5, 2, 2.75, and 3.8 when referring to, for example, measurements). Disclosure of a narrower range or more specific group in addition to a broader range or larger group is not a disclaimer of the broader range or larger group.

The invention may be embodied in many different forms and should not be construed as limited to the embodiments set forth herein. Rather, these embodiments are provided so that this disclosure will satisfy applicable legal requirements.

Those skilled in the art will appreciate that while preferred embodiments are discussed in more detail below, multiple embodiments of the polymer compositions, stabilized polymeric articles, and methods of stabilizing polymers against the deleterious effects of UV-C light are contemplated as being within the scope of the invention. Thus, it should be noted that any feature described with respect to one aspect or one embodiment of the invention is interchangeable with another aspect or embodiment of the invention unless otherwise stated. It will be understood by those skilled in the art that any description of the invention, even though described in relation to a specific embodiment or drawing, is applicable to and interchangeable with other embodiments of the invention.

Accordingly, in one aspect the invention provides polymer compositions for making stabilized polymeric articles that are resistant to discoloration, cracking, and/or crazing upon repeated or prolonged exposure to UV-C (190-280 nm) light. In any or all embodiments, the polymer compositions can include, but are not limited to: (i) an organic polymeric material; and (ii) a stabilizer composition having: an antioxidant selected from the group consisting of hindered phenols, phosphites and phosphonites, and mixtures thereof; and a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVINTM 770) alone. In any or all embodiments of the polymer compositions, at least one of reduced discoloration, cracking, and/or crazing upon exposure to UV-C light is associated with the use of the light stabilizer in combination with the antioxidant, even where barium compounds (such as barium salts) are absent from the stabilizer composition, compared to the antioxidant in the absence of the light stabilizer.

Reduced discoloration is measured by comparing delta E and/or delta Yellow Index (YI) after 24 hours of exposure to UV-C light with an average irradiance of 1200 μW/cm² at 254 nm as illustrated in the present examples. Delta E is measured according to ASTM D2244-16 and delta YI is measured according to ASTM E313-20. For a determination of reduced discoloration, the color change associated with the combination of light stabilizer and antioxidant is compared to the same amount of the same antioxidant in the absence of the light stabilizer.

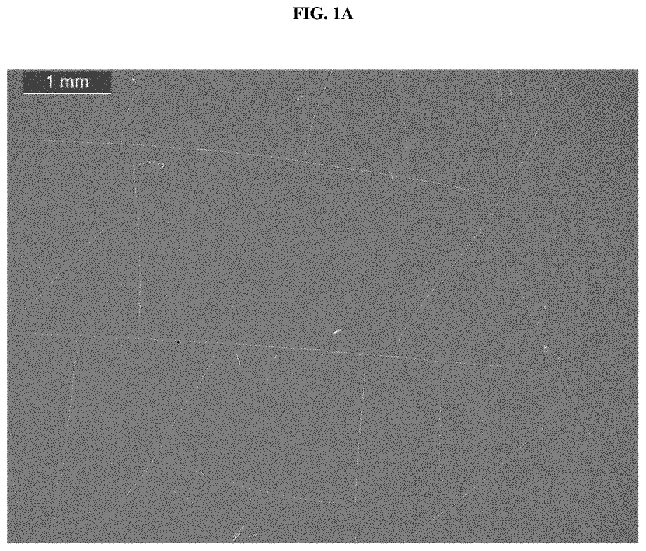

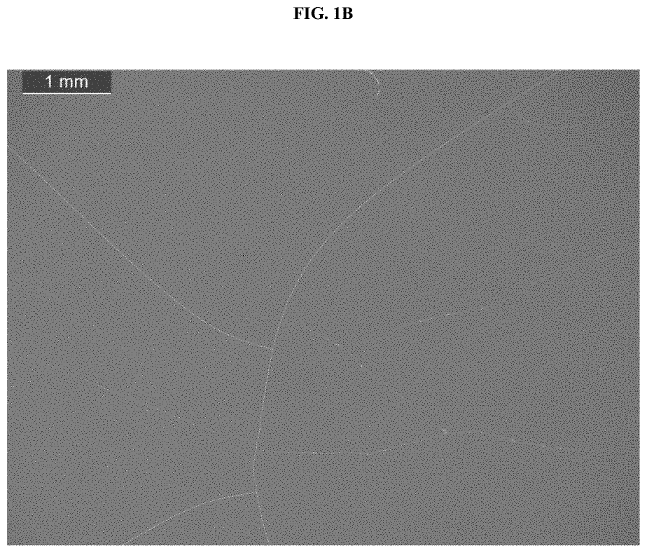

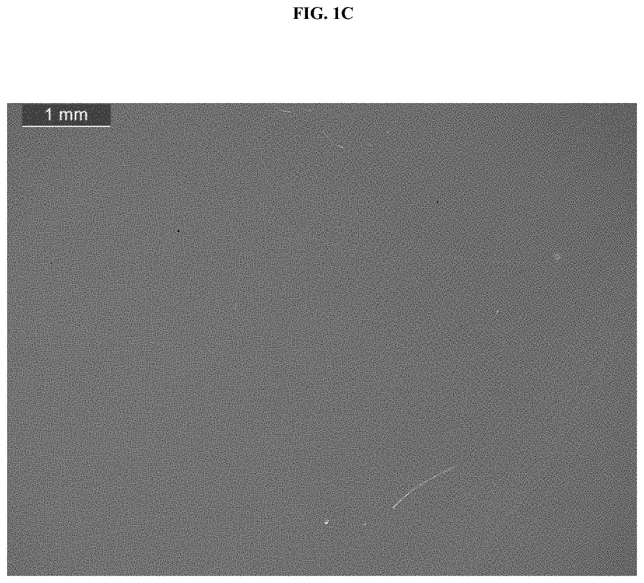

Crazing is the formation of a network of microscopic cracks (crazes) on the surface of a polymeric organic material. A craze is different than a crack in that it cannot be felt tactilely on the surface and the crazed article can continue to support a load. For a determination of reduced cracking or crazing, the cracking or crazing associated with the combination of light stabilizer and antioxidant is compared to the cracking or crazing associated with the same amount of the same antioxidant in the absence of the light stabilizer. In particular, cracking or crazing is determined by visual inspection or by inspection using a digital stereo microscope at 20× magnification after 24 hours of exposure to UV-C light with an average irradiance of 1200 μW/cm² at 254 nm as illustrated in present Examples 5-10, and FIGS. 1A-C.

In the present examples, the total amount of antioxidant (e.g., hindered phenol and phosphite or phosphonite) is 0.08%, 0.10%, or 0.15% by weight, based on the total weight of the polymer composition. However, depending upon the type of antioxidant, the polymeric organic material, and the degree of stabilization desired, the antioxidant can be present at from 0.001 to 5.0 wt. %, preferably from 0.005 to 3.0 wt. %, and more preferably from 0.01 to 1.0% by weight, based on the total weight of the polymer composition.

In the present examples, the total amount of light stabilizer (e.g., HALS, UVA, hindered benzoates) is 0.40%, 0.60%, 0.80%, or 1.6% by weight, based on the total weight of the polymer composition. However, depending upon the type of light stabilizer, the polymeric organic material, and the degree of stabilization desired, the light stabilizer can be present at from 0.005 to 5.0% by weight, preferably from 0.01 to 2.0% by weight, based on the total weight of the polymer composition.

In any or all embodiments, the amount of the stabilizer composition (e.g., total amount of antioxidant and light stabilizer in certain embodiments) is from 0.001 to 10.0% by weight, preferably from 0.005 to 5.0% by weight, and more preferably from 0.01 to 3.0% by weight, based on the total weight of the polymer composition.

The organic polymeric material can be any polymeric organic material subject to discoloration upon exposure to UV-C (190-280 nm) light. For example, the polymeric organic polymeric material can be at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene- acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

In any or all embodiments the organic polymeric material is a polyolefin. The polyolefin can be at least one of (i) polyethylene, polypropylene, polyisobutylene, polybut-1-ene, or poly-4-methylpent-1-ene; (ii) polyisoprene or polybutadiene; (iii) cyclopentene or norbornene; (iv) optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); (v) a thermoplastic olefin (TPO); or (vi) copolymers of at least one of mono-, di-, or cyclo-olefins.

The antioxidant is selected from the group consisting of hindered phenols, phosphites and phosphonites, and mixtures thereof. In any or all embodiments, the antioxidant includes a hindered phenol. The hindered phenol can have at least one group according to Formulae (IVa), (IVb), or (IVc):

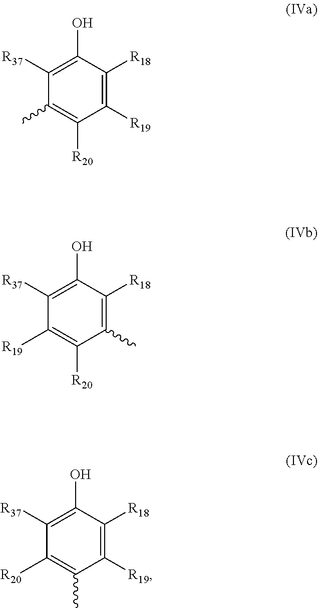

wherein: “ [symbol] ” indicates the point of attachment (via a carbon-carbon single bond) of the molecular fragment to a parent compound; R₁₈ in each of Formulae (IVa), (IVb), or (IVc) is hydrogen or C₁₋₁₂ hydrocarbyl; each of R₁₉ and R₂₀ in Formulae (IVa), (IVb), or (IVc) is independently hydrogen or C₁-C₂₀ hydrocarbyl; and R₃₇ in each of Formulae (IVa), (IVb), or (IVc) is C₁-C₁₂ hydrocarbyl. In any or all embodiments, each of R₁₈ and R₃₇ in Formulae (IVa), (IVb), or (IVc) is independently chosen from methyl or tent-butyl.

Examples of hindered phenols suitable for use with the invention disclosed herein are provided below, organized by chemical genus:

a) Alkylated monophenols including, for example 2,6-di-tert-butyl-4- methylphenol, 2-tert-butyl-4,6-dimethylphenol, 2,6-di-tort-butyl-4-ethylphenol, 2,6-di-tert-butyl-4-n-butylphenol, 2,6-di-tert-butyl-4-isobutylphenol, 2,6-di-cyclopentyl-4-methylphenol, 2-α-methylcyclohexyl)-4,6-dimethylphenol, 2,6-di-octadecyl-4-methylphenol, 2,4,6-tri-cyclohexylphenol, 2,6-di-tert-butyl-4-methoxymethylphenol, or 2,6-dinonyl-4-methylphenol.

b) Alkylthiomethylphenols including, for example, 2,4-dioctylthiomethyl-6-tert-butylphenol, 2,4-dioctylthiomethyl-6-methylphenol, 2,4-dioctylthiomethyl-6-ethylphenol, or 2,6-di-dodecylthiomethyl-4-nonylphenol.

c) Hydroquinones and alkylated hydroquinones including, for example, 2,6-di-tert-butyl-4-methoxyphenol, 2,5-di-tent-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, or bis(3,5-di-tert-butyl-4-hydroxyphenyl) adipate.

d) Hydroxylated thiodiphenyl ethers including, for example, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), or 4,4′-bis(2,6-dimethyl-4-hydroxyphenyl)disulfide.

e) Alkylidenebisphenols including, for example, 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5 -tert-butyl-4-hydroxy-2-methylphenyl)-3-n-dodecylmercaptobutane, ethylene glycol bis[3,3 -bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, or 1,1,5,5-tetra-(5-tert-butyl-4-hydroxy-2-methylphenyl)pentane.

f) O-. N- and S-benzyl compounds including, for example, 3,5,3′,5′-tetra-tert-butyl-4,4′-dihydroxydibenzyl ether, octadecyl-4-hydroxy-3,5- dimethylbenzylmercapto acetate, tridecyl-4-hydroxy-3,5 -di-tert-butylbenzylmercapto, tris(3,5-di-tert-butyl-4-hydroxybenzyl)amine, bis(4-tert-butyl-3 -hydroxy-2,6-dimethylbenzyl)dithioterephthalate, bis(3,5-di-tert-butyl-4-hydroxybenzyl)sulfide, or isooctyl-3,5-di-tert-butyl-4-hydroxybenzylmercaptoacetate.

g) Hydroxybenzylated malonates including, for example, dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, or bis[4-(1,1,3,3-tetramethylbutyl)phenyl]-2,2-bis(3,5-di-tert-butyl-4-hydroxybenzyl)malonate.

h) Aromatic hydroxybenzyl compounds including, for example, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, or 2,4,6-tris(3,5-di-tert-butyl-4-hydroxybenzyl)phenol.

i) Triazine compounds including, for example, 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, or 1,3,5-tris(3,5-dicyclohexyl-4-hydroxybenzyl)isocyanurate.

j) Benzylphosphonates including, for example, dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

k) Acylaminophenols including, for example, 4-hydroxylauranilide, 4-hydroxystearanilide, octyl N-(3,5-di-tert-butyl-4-hydroxyphenyl)carbamate.

l) Esters of [5-(3,5-di-tert-butyl-4-hydroxyphenyl)propionic acid with mono- or poly-hydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, 2,2,4-trimethyl-1,6-hexanediol, trimethylolpropane, or 4-hydroxymethyl-1-phospha-2,6,7-trioxabicyclo[2.2.2]octane.

m) Esters of β-(5-tert-butyl-4-hydroxy-3-methylphenyl)propionic acid with mono- or poly-hydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, 2,2,4-trimethyl-1,6-hexanediol, trimethylolpropane, or 4-hydroxymethyl-1-phospha-2,6,7-trioxabicyclo[2.2.2]octane; or 3,9-bis[2-{3-(3-tert-butyl-4-hydroxy-5-methylphenyl)propionyloxy}-1,1-dimethylethyl]-2,4,8,10-tetraoxaspiro[5.5]undecane.

n) Esters of β-(3,5-dicyclohexyl-4-hydroxyphenyl)propionic acid with mono- or poly-hydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, 2,2,4-trimethyl-1,6-hexanediol, trimethylolpropane, or 4-hydroxymethyl-1-phospha-2,6,7-trioxabicyclo[2.2.2]octane.

o) Esters of 3,5-di-tert-butyl-4-hydroxyphenvl acetic acid with mono- or poly-hydric alcohols, e.g. methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, 2,2,4-trimethyl-1,6-hexanediol, trimethylolpropane, or 4-hydroxymethyl-1-phospha-2,6,7-trioxabicyclo[2.2.2]octane.

p) Amides of [3-(3,5-di-tert-butyl-4-hydroxyphenyl)propionic acid, for example, N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, or N,N′-bis[2-(3-[3,5-di-tert-butyl-4-hydroxyphenyl]propionyloxy)ethyl]oxamide.

In any or all embodiments of the polymer compositions described herein, the hindered phenol is at least one of:

1,3,5-tris(4-tert-butyl-3-hydroxy-2,6-dimethylbenzyl)-1,3,5-triazine-2,4,6-(1H,3H,5H)-trione (CYANOX™ 1790),

1,3,5-tris(3,5-di-tert-butyl-4-hydroxybenzyl)-1,3,5-triazine-2,4,6-(1H,3H,5H)-trione (IRGANOX™ 3114),

1,1,3-tris(2′-methyl-4′-hydroxy-5′-tert-butylphenyl)butane,

triethylene glycol bis[3-(3-tert-butyl-4-hydroxy-5-methylphenyl)propionate],

4,4′-thiobis(2-tert-butyl-5-methylphenol),

2,2′-thiodiethylene bis[3-(3-tert-butyl-4-hydroxyl-5-methylphenyl)propionate],

octadecyl 3-(3-tert-butyl-4-hydroxy-5-methylphenyl)propionate,

pentaerythritol (3-tert-butyl-4-hydroxy-5-methylphenyl)propionate,

N,N′-hexamethylene bis[3-(3-tert-butyl-4-hydroxy-5-methylphenyl)propionamide],

di(4-tert-butyl-3-hydroxy-2,6-dimethylbenzyl)thiodipropionate,

pentaerythritol tetrakis(3-(3,5-di-tert-butyl-4-hydroxyphenyl)propionate) (IRGANOX™ 1010),

octadecyl 3-(3,5-di-tert-butyl-4-hydroxyphenyl)propionate (IRGANOX™ 1076), or

N,N′-bis(3,5-di-tert-butyl-4-hydroxylphenyl propionyl)hydrazine (IRGANOX™ 1024).

In any or all embodiments of the polymer compositions, the hindered phenol can be at least one of pentaerythritol tetrakis(3-(3,5-di-tert-butyl-4-hydroxyphenyl)propionate) (IRGANOX™ 1010), octadecyl 3-(3,5-di-tert-butyl-4-hydroxyphenyl)propionate (IRGANOX™ 1076), 1,3,5-tris(3,5-di-tert-butyl-4-hydroxybenzyl)-1,3,5-triazine-2,4,6-(1H,3H,5H)-trione (IRGANOX™ 3114), or N,N′-bis(3,5-di-tert-butyl-4-hydroxylphenyl propionyl)hydrazine (IRGANOX™ 1024).

In the same or other embodiments, the antioxidant is selected from the group consisting of hindered phenols, phosphites and phosphonites, and mixtures thereof. In any or all embodiments, the antioxidant includes a phosphite or phosphonite. The phosphite or phosphonite can be at least one of:

i) a compound according to any of Formulae (1) to (7):

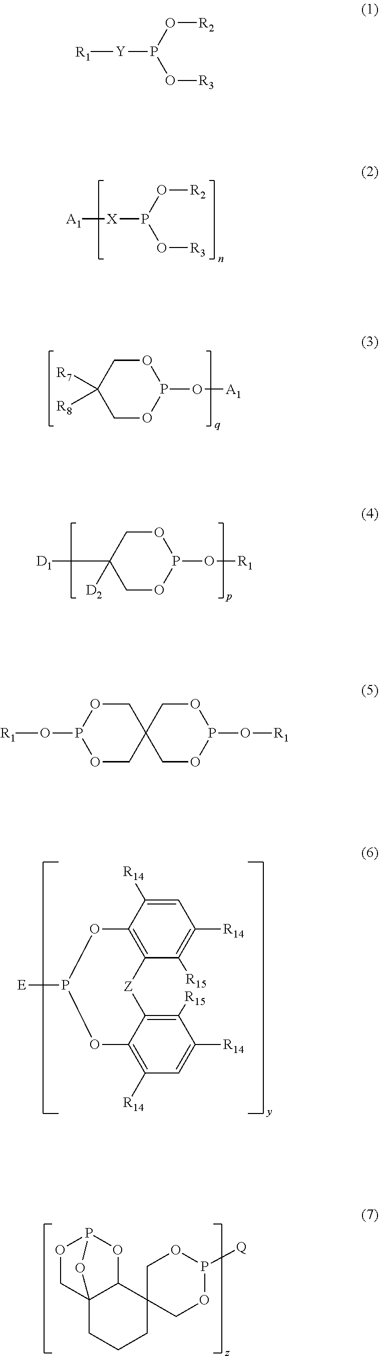

wherein:

the indices are integral and n is 2, 3 or 4; p is 1 or 2; q is 2 or 3; y is 1, 2 or 3; and z is 1 to 6;

A₁, if n or q is 2, is C₂-C₁₈ alkylene; C₂-C₁₂ alkylene interrupted by oxygen, sulfur or —NR₄—, a radical of the formulae:

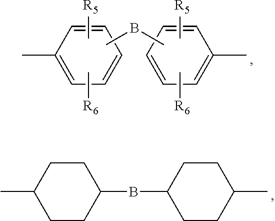

or phenylene;

A₁, if n or q is 3, is a divalent radical of the formula —CᵣH₂ᵣ₋₁—, wherein r is an integer from 4 to 12;

A₁, if n is 4, is

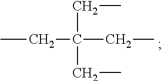

B is a direct bond, —CH₂—, —CHR₄—, —CR₁R₄—, sulfur, C₅-C₇ cycloalkylidene, or cyclohexylidene which is substituted by from 1 to 4 C₁-C₄ alkyl radicals in position 3, 4 and/or 5;

D₁, if p is 1, is C₁-C₄ alkyl and, if p is 2, is —CH₂OCH₂—;

D₂ is C₁-C₄ alkyl;

E, if y is 1, is C₁-C₁₈ alkyl, —OR₁ or halogen;

E, if y is 2, is —O-A₂-O—, wherein A₂ is as defined for Aₗ when n is 2;

E, if y is 3, is a radical of the formula R₄C(CH₂O)₃ or N(CH₂CH₂O—)₃;

Q is the radical of an at least z-valent mono- or poly-alcohol or phenol, this radical being attached via the oxygen atom of the OH group of the mono- or poly-alcohol or phenol to the phosphorus atom;

R₁, R₂ and R₃ are each independently C₁-C₁₈ alkyl which is unsubstituted or substituted by halogen, —COOR₄, —CN or —CONR₄R₄; C₂-C₁₈ alkyl interrupted by oxygen, sulfur or —NR₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula

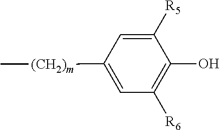

in which m is an integer from 3 to 6;

R₄ is hydrogen, C₁-C₈ alkyl, C₅-C₁₂ cycloalkyl or C₇-C₉ phenylalkyl;

R₅ and R₆ are each independently hydrogen, C₁-C₈ alkyl or C₅-C₆ cycloalkyl,

R₇ and R₈, if q is 2, are each independently C₁-C₄ alkyl or together are a 2,3-dehydropentamethylene radical; and R₇ and R₈, if q is 3, are each methyl;

each instance of R₁₄ is independently chosen from hydrogen, C₁-C₉ alkyl or cyclohexyl;

each instance of R₁₅ is independently hydrogen or methyl;

X and Y are each a direct bond or oxygen;

Z is a direct bond, methylene, —C(R₁₆)₂—or sulfur, and

R₁₆ is C₁-C₈ alkyl; or

ii) a trisarylphosphite compound according to Formula 8:

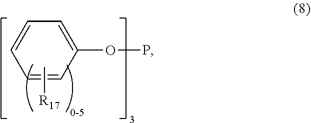

wherein:

R₁₇ is a substituent present at from 0 to 5 instances of the aromatic ring of Formula 8 and in each instance is independently C₁-C₂₀ alkyl, C₃-C₂₀ cycloalkyl, C₄-C₂₀ alkyl cycloalkyl, C₆-C₁₀ aryl, or C₇-C₂₀ alkylaryl.

In any or all embodiments, the phosphite or phosphonite can be, for example, at least one of:

triphenyl phosphite,

diphenyl alkyl phosphites,

phenyl dialkyl phosphites,

trilauryl phosphite,

trioctadecyl phosphite,

distearyl pentaerythritol phosphite,

tris(2,4-di-tert-butylphenyl) phosphite (IRGAFOS™ 168),

tris(4-nonylphenyl) phosphite,

a compound of Formulae (A), (B), (C), (D), (E), (F), (G), (H), (J), (K), or (L):

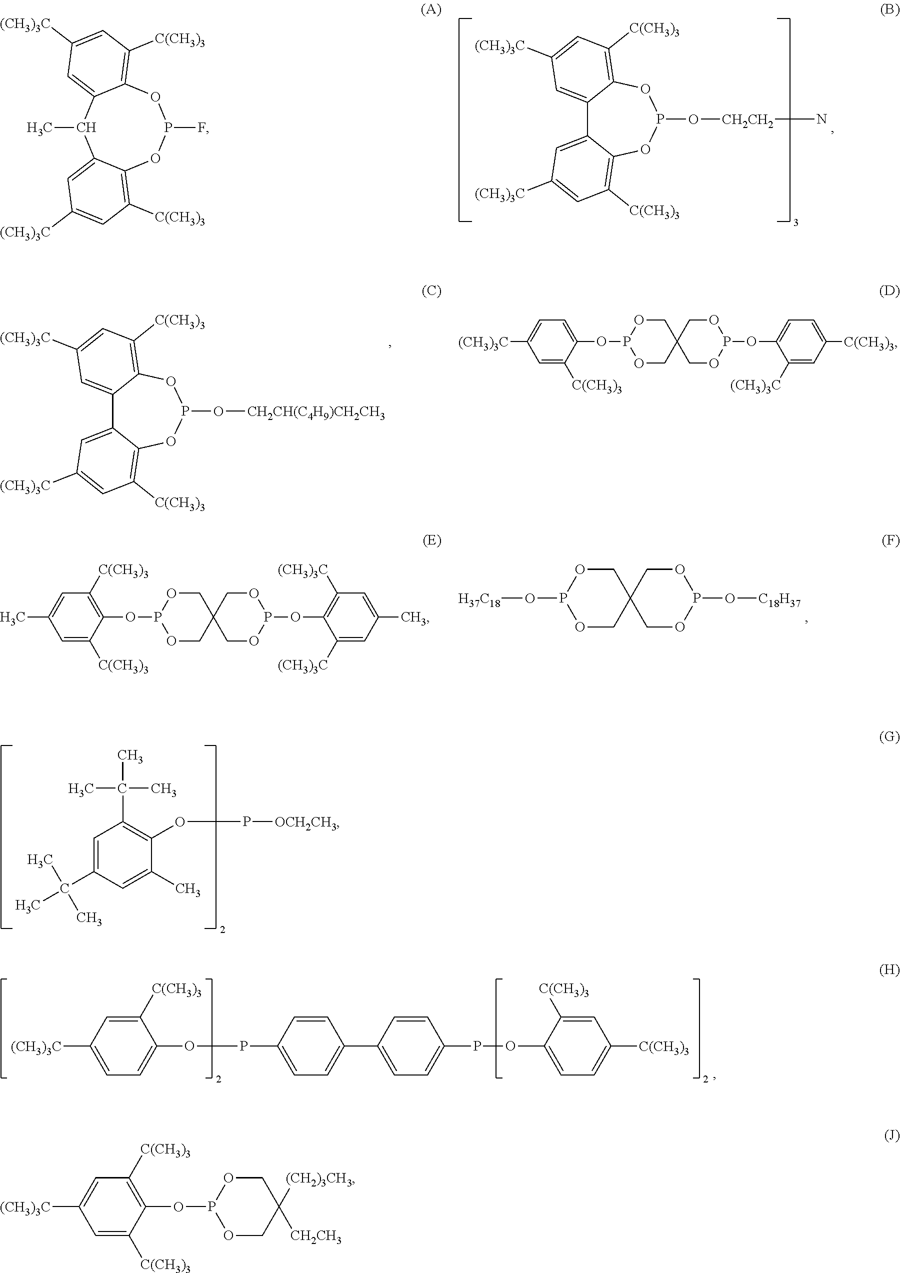

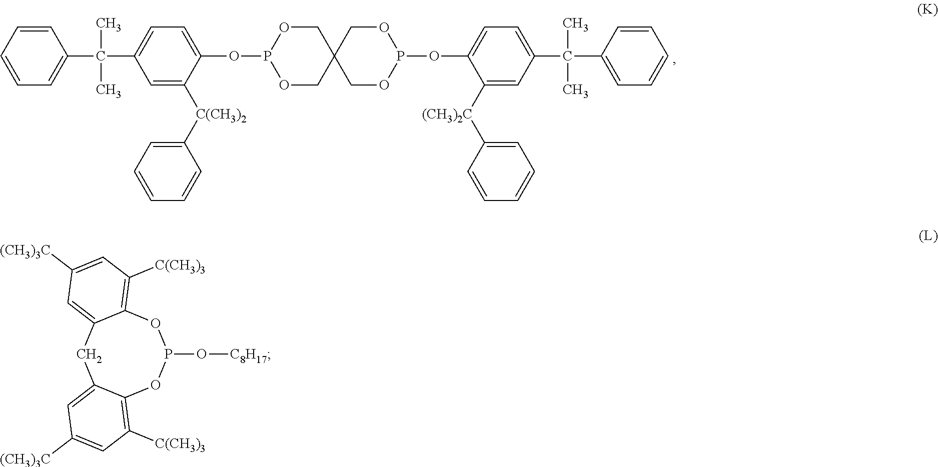

2-butyl-2-ethyl-1,3-propanediol 2,4,6-tri-tert-butylphenol phosphite,

bis(2,6-di-tert-butyl-4-methlphenyl) pentaerythritol diphosphite,

2-butyl-2-ethyl-1,3-propanediol 2,4-di-cumylphenol phosphite,

2-butyl-2-ethyl-1,3-propanediol 4-methyl-2,6-di-tert-butylphenol phosphite, or

bis(2,4,6-tri-tert-butyl-phenyl) pentaerythritol diphosphate.

In any or all embodiments, the phosphite or phosphonite is at least one of tris(2,4-di-tert-butylphenyl)phosphite (IRGAFOS™ 168), triphenyl phosphite, tris(4-nonylphenyl) phosphite, bis(2,4-dicumylphenyl)pentaerythritol diphosphite (DOVERPHOS™ S9228), or tetrakis(2,4-di-tert-butylphenyl)-4,4′-biphenylene-diphosphonite (IRGAFOS™ P-EPQ).

The polymer compositions according to the invention also include a light stabilizer selected from the group consisting of hindered amine light stabilizers (HALS), UV absorbers (UVA), hindered benzoates, and mixtures thereof. In any or all embodiments, the light stabilizer includes a hindered amine light stabilizer, even in the absence of UV absorber or other light stabilizers, with the proviso that the HALS is not bis(2,2,6,6,-tetramethyl-4-piperidyl) sebacate (TINUVIN™ 770) alone. The hindered amine light stabilizer can include at least one functional group according to Formula (II):

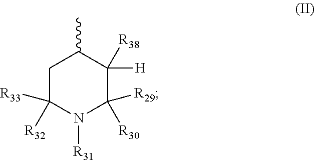

wherein:
R₃₁ is hydrogen, OH, C₁-C₂₀ hydrocarbyl, —CH₂CN, C₁-C₁₂ acyl, or C₁-C₁₈ alkoxy;
R₃₈ is hydrogen or C₁-C₈ hydrocarbyl; and
R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or

at least one functional group according to Formula (IIa):

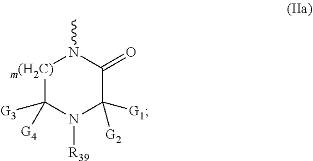

wherein:

m is an integer from 1 to 2;

R₃₉ is hydrogen, OH, C₁-C₂₀ hydrocarbyl, —CH₂CN, C₁-C₁₂ acyl, or C₁-C₁₈ alkoxy; and

G₁-G₄ are each independently C₁-C₂₀ hydrocarbyl.

In any or all embodiments, the hindered amine light stabilizer (HALS) can be, for example, at least one of:

bis(2,2,6,6-tetramethylpiperidin-4-yl) succinate;

bis(1,2,2,6,6-pentamethylpiperidin-4-yl) sebacate;

bis(1-octyloxy-2,2,6,6-tetramethylpiperidyl) succinate;

bis(1-octyloxy-2,2,6,6-tetramethylpiperidin-4-yl) sebacate (TINUVIN™ 123);

bis(1,2,2,6,6-pentamethylpiperidin-4-yl) n-butyl 3,5-di-tert-butyl-4-hydroxybenzylmalonate;

a condensate of 1-(2-hydroxyethyl)-2,2,6,6-tetramethyl-4-hydroxypiperidine and succinic acid (TINUVIN™ 622);

2,2,6,6-tetramethylpiperidin-4-yl stearate;

2,2,6,6-tetramethylpiperidin-4-yl dodecanate;

1,2,2,6,6-pentamethylpiperidin-4-yl stearate;

1,2,2,6,6-pentamethylpiperidin-4-yl dodecanate;

a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);

tris(2,2,6,6-tetramethylpiperidin-4-yl) nitrilotriacetate;

4-stearyloxy-2,2,6,6-tetramethylpiperidine;

a condensate of N,N′-bis(2,2,6,6-tetramethylpiperidin-4-yl)hexamethylenediamine and 4-morpholino-2,6-dichloro-1,3,5-triazine (CYASORB™ UV-3346);

a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);

a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);

a condensate of 2-chloro-4,6-bis(4-n-butylamino-1,2,2,6,6-pentamethylpiperidyl)-1,3,5-triazine and 1,2-bis-(3-aminopropylamino)ethane;

a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);

a mixture of 4-hexadecyloxy- and 4-stearyloxy-2,2,6,6-tetramethylpiperidine (CYASORB™ UV-3853);

a mixture of 4-hexadecyloxy- and 4-stearyloxy-1,2,2,6,6-pentamethylpiperidine;

a condensate of N,N′-bis(2,2,6,6-tetramethylpiperidin-4-yl)hexamethylenediamine and 4-cyclohexylamino-2,6-dichloro-1,3,5-triazine;

a condensate of 1,2-bis(3-aminopropylamino)ethane, 2,4,6-trichloro-1,3,5-triazine, and 4-butylamino-2,2,6,6-tetramethylpiperidine;

a condensate of N,N′-bis(2,2,6,6-tetramethylpiperidin-4-yl)hexamethylenediamine and 4-cyclohexylamino-2,6-dichloro-1,3,5-triazine;

tetrakis(2,2,6,6-tetramethylpiperidin-4-yl)-1,2,3,4-butanetetracarboxylate;

tetrakis(1,2,2,6,6-pentamethylpiperidin-4-yl)-1,2,3,4-butanetetracarboxylate;

1,2,3,4-butanetetracarboxylic acid, 2,2,6,6-tetramethylpiperidinyl-4-yl tridecyl ester;

1,2,3,4-butanetetracarboxylic acid, 1,2,2,6,6-pentamethylpiperidin-4-yl tridecyl ester;

formamide, N,N′-1,6-hexanediylbis[N-(2,2,6,6-tetramethylpiperidin-4-yl) (UVINUL™ 4050);

a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);

a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371;

N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200);

TINUVIN™ XT-850/XT-855); or

N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

The polymer compositions according to the invention have been described to include a light stabilizer selected from the group consisting of hindered amine light stabilizers (HALS), UV absorbers (UVA), hindered benzoates, and mixtures thereof. In any or all embodiments, the light stabilizer includes a UV absorber (even in the absence of HALS or other light stabilizers), that is at least one 2-(2′-hydroxyphenyl)-s-triazine, 2-hydroxybenzophenone, 2-(2′-hydroxyphenyl)benzotriazole, or benzoxazinone.

In any or all embodiments, the light stabilizer includes at least one 2-(2′-hydroxyphenyl)-s-triazine. The 2-(2′-hydroxyphenyl)-s-triazine can be a compound according to Formula (I):

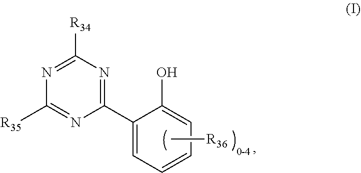

wherein each of R₃₄ and R₃₅ is independently chosen from a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl,

wherein the C₆-C₁₀ aryl group is optionally substituted at from 1 to 3 substitutable positions with at least one of OH, halogen, C₁-C₁₂ alkyl, C₁-C₁₂ alkoxy, C₁-₁₂ alkoxyester, C₂-₁₂ alkanoyl, or phenyl, wherein the phenyl is optionally substituted at from 1 to 3 substitutable positions with at least one of OH, halogen, C₁-₁₂ alkyl, C₁-₁₂ alkoxy, C₁-₁₂ alkoxyester, or C₂-₁₂ alkanoyl; and

each R₃₆ is independently chosen from OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

In any or all embodiments, the 2-(2′-hydroxyphenyl)-s-triazine can be at least one of:

4,6-diphenyl-2-(4-hexyloxy-2-hydroxyphenyl)-s-triazine (TINUVIN™ 1577),

4,6-bis-(2,4-dimethylphenyl)-2-(2-hydroxy-4-octyloxyphenyl)-s-triazine (CYASORB™ 1164),

2,4-bis[2-hydroxy-4-(2-hydroxy-4-(2-hydroxyethoxy)phenyl]-6-(2,4-dimethylphenyl)-s-triazine,

mixture of 4,6-bis(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),

4,6-bis(2,4-dimethylphenyl)-2-(2-hydroxy-4(3-(2-ethylhexyloxy)-2-hydroxypropoxy)-phenyl)-s-triazine (TINUVIN™ 405),

4,6-bis(2,4-dimethylphenyl)-2-(2-hydroxy-4(3-(2-ethylhexyloxy)-2-hydroxypropoxy)-phenyl)-s-triazine,

2,4-bis(2,4-dimethylphenyl)-6-[2-hydroxy-4-[(octyloxycarbonyl)ethylideneoxy]phenyl]-s-triazine (TINUVIN™ 479),

2,4-bis(4-biphenylyl)-6-[2-hydroxy-4-[(octyloxycarbonyl)ethylideneoxy]phenyl]-s-triazine,

2,4-bis(4-biphenylyl)-6-[2-hydroxy-4-(2-ethylhexyloxy)phenyl]-s-triazine (TINUVIN™ 1600),

2,4-bis(2-hydroxy-4-butyloxyphenyl)-6-(2,4-bis-butyloxyphenyl)-s-triazine (TRIAZINE™ 460),

2,4,6-tri s[2-hydroxy-4-(3-sec-butyloxy-2-hydroxypropyloxy)-phenyl]-s-triazine, or

2,4,6-tris[2-hydroxy-4-[(octyloxycarbonyl)ethylideneoxy]phenyl]-s-triazine (TINUVIN™ 477).

In the same or other embodiments of the polymer compositions according to the invention, the light stabilizer includes a 2-hydroxybenzophenone. The 2-hydroxybenzophenone can be at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-531), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

In the same or other embodiments of the polymer composition according to the invention, the light stabilizer includes a 2-(2′-hydroxyphenyl)benzotriazole. The 2-(2′-hydroxyphenyl)benzotriazole can be at least one of 2-(2′-hydroxy-5′-methylphenyl)benzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVINTM 1130), 2-[2′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, or 2-(5′-tert-butyl-2′-hydroxyphenyl)benzotriazole.

In the same or other embodiments of the polymer composition according to the invention, the light stabilizer includes a benzoxazinone. The benzoxazinone can be at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p-nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-0-methoxyphenyl-3,1-benzoxazin-4-one, 2-cyclohexyl-3,1-benzoxazin-4-one, 2p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6-or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

In the same or other embodiments of the polymer composition according to the invention, the light stabilizer includes a hindered benzoate. The hindered benzoate can be present even in the absence of HALS or UV absorber in certain embodiments. The hindered benzoate can be a compound according to Formula (VI):

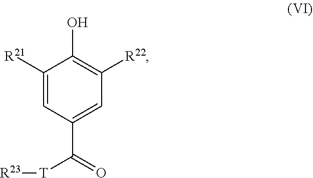

wherein:

each of R²¹ and R²² is independently a C₁₋C₁₂ alkyl;

T is O or NR²⁴, wherein R²⁴ is H or a C₁-C₃₀ hydrocarbyl; and

R²³ is H or a C₁-C₃₀ hydrocarbyl.

The hindered benzoate can be at least one of 2,4-di-tert-butylphenyl 3,5-di-tert-butyl-4-hydroxybenzoate (TINUVIN™ 120), hexadecyl 3,5-di-tert-butyl-4-hydroxybenzoate (CYASORB™ UV-2908), octadecyl 3,5-di-tert-butyl-4-hydroxybenzoate, octyl 3,5-di-tert-butyl-4-hydroxybenzoate, decyl 3,5-di-tert-butyl-4-hydroxybenzoate, dodecyl 3,5-di-tert-butyl-4-hydroxybenzoate, tetradecyl 3,5-di-tert-butyl-4-hydroxybenzoate, behenylyl 3,5-di-tert-butyl-4-hydroxybenzoate, 2-methyl-4,6-di-tert-butylphenyl 3,5-di-tert-butyl-4-hydroxybenzoate, or butyl 3-[3-tert-butyl-4-(3,5-di-tert-butyl-4-hydroxybenzoyloxy)phenyl]propionate.

The polymer compositions described herein can further include a thiosynergist. The thiosynergist can be at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

The polymer compositions according to the invention can further include an inorganic compound. In any or all embodiments, the inorganic compound can be at least one of titanium dioxide, barium sulfate, zinc oxide, or cerium(IV) oxide. The polymer compositions can also be free of barium compounds. Barium compounds include, for example, barium salts such as barium sulfate. “Free of” means that the polymer compositions described herein have less than 1% by weight, less than 0.1% by weight, less than 0.01% by weight, or less than 0.001% by weight of the barium compound, based on the total weight of the polymer composition.

In a second aspect, the invention provides stabilized polymeric articles that include the polymer compositions described herein, which articles are resistant to discoloration, cracking and/or crazing upon exposure to UV-C (190-280 nm) light. At least one of reduced discoloration, cracking, or crazing upon exposure to UV-C light is associated with the use of the light stabilizer in combination with the antioxidant, even where barium compounds (such as barium salts) are absent from the stabilizer composition, compared to the antioxidant in the absence of the light stabilizer.

As can be seen from the present examples, at least one of reduced discoloration or reduced cracking and/or crazing upon exposure to UV-C light is associated with the use of the light stabilizer in combination with the antioxidant, even where barium compounds (such as barium salts) are absent from the stabilizer composition, compared to the antioxidant in the absence of the light stabilizer. Thus, the stabilizer compositions described herein are advantageously used to reduce discoloration and/or reduce cracking or crazing of organic polymer materials upon exposure to UV-C (190-280 nm) light compared to polymer compositions comprising the antioxidant alone. Accordingly, methods of stabilizing organic polymeric materials against the effects of UV-C (190-280 nm) light include adding to the organic polymeric material the stabilizer composition having: an antioxidant selected from the group consisting of hindered phenols, phosphites and phosphonites, and mixtures thereof; and a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVIN™ 770) alone. At least one of reduced discoloration, cracking, or crazing upon exposure to UV-C light is associated with the use of the light stabilizer in combination with the antioxidant compared to the antioxidant in the absence of the light stabilizer.

As discussed above, for a determination of reduced discoloration, the color change associated with the combination of light stabilizer and antioxidant is compared to the same amount of the same antioxidant in the absence of the light stabilizer. In particular, reduced discoloration is measured by comparing delta E and/or delta Yellow Index (YI) after 24 hours of exposure to UV-C light with an average irradiance of 1200 μW/cm² at 254 nm as illustrated in the present examples. Delta E is measured according to ASTM D2244-16 and delta YI is measured according to ASTM E313-20.

Likewise, for a determination of reduced cracking or crazing, the amount of cracking or crazing associated with the combination of light stabilizer and antioxidant is compared to the same amount of the same antioxidant in the absence of the light stabilizer. In particular, cracking or crazing is determined by visual inspection or by inspection using a digital stereo microscope at 20x magnification after 24 hours of exposure to UV-C light with an average irradiance of 1200 μW/cm² at 254 nm as illustrated in present Examples 5-10, and FIGS. 1A-C.

All embodiments of the polymer compositions described herein likewise apply to the methods of stabilizing the organic polymeric materials. Thus, in the methods of stabilizing the polymeric organic materials, the total amount of antioxidant is from 0.001 to 5.0% by weight and the total amount of light stabilizer is from 0.01 to 2.0% by weight, both based on the total weight of the polymer composition.

The antioxidant, light stabilizer, and optionally other additives, can be added to the polymeric organic materials by any suitable method known to those of skill in the art, for example by direct mixing, dry mixing, melting, or by extruding, pelletizing, grinding, and molding. The additives can be added neat, i.e., in the absence of a solvent or polymeric carrier. The additives can also be added as a solution or dispersion in a solvent, optionally followed by evaporation of the solvent. The additives can also be added as a masterbatch, i.e., as a concentrate in a polymeric organic material. The additives in particulate form can also be encapsulated by waxes, oils, or polymers for addition to the polymeric organic material.

The polymer compositions described herein can be contained in a kit. The kit can have single or multiple components, each component selected from the group consisting of the organic polymeric material, the antioxidants, the light stabilizers, and other additives described herein, and combinations thereof. Thus, one or more components of a polymer composition can be in a first container, and one or more other components of the polymer composition can optionally be in a second or more containers. The containers can be packaged together, and the kit can include administration or mixing instructions on a label or on an insert included with the kit, optionally with a web address or bar code for further information. In addition to the components of the polymer composition, the kit can include additional functional parts or means for administering or mixing the components, including solvents.

The antioxidant, light stabilizer, and optionally other additives, can be added before or during formation of the organic polymeric material from monomers by polymerization or before crosslinking of the polymeric organic material. The additives can be premixed, or preblended before adding to the polymeric organic material. The additives in the form of melts, or solutions or dispersions in solvents, can also be sprayed onto the polymeric organic material.

The polymer compositions as defined herein can be utilized in industrial manufacturing processes to produce stabilized polymeric articles. Thus, methods of making a stabilized polymeric article includes adding to an organic polymeric material a stabilizer composition having: an antioxidant selected from the group consisting of hindered phenols, phosphites and phosphonites, and mixtures thereof; and a light stabilizer selected from the group consisting of hindered amine light stabilizers (HALS), UV absorbers (UVA), hindered benzoates, and mixtures thereof; and shaping the organic polymeric material containing the stabilizer composition into the stabilized polymeric article. The shaping can be done, for example, by molding, extrusion, blowing, casting, thermoforming, compacting, or variations or combinations thereof. The molding can be, for example, injection molding, rotomolding, blow molding, reel-to-reel molding, metal injection molding, compression molding, transfer molding, dip molding, gas assist molding, insert injection molding, micro molding, reaction injection molding, two shot injection molding, or variations or combinations thereof.

The polymer compositions described herein are advantageously used to make stabilized polymeric articles that are more resistant to discoloration, cracking, or crazing upon exposure to a UV-C (190-280 nm) light, for example from a disinfectant (germicidal) light source, compared to polymer compositions comprising other hindered phenols and organic phosphites. Thus, a stabilized polymeric article resistant to discoloration, cracking, or crazing upon exposure to UV-C (190-280 nm) light includes a polymer composition having an antioxidant selected from the group consisting of hindered phenols, phosphites and phosphonites, and mixtures thereof; and a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVINTM 770) alone. At least one of reduced discoloration, cracking, or crazing upon exposure to UV-C light is associated with the use of the light stabilizer in combination with the antioxidant, even where barium compounds (such as barium salts) are absent from the stabilizer composition, compared to the antioxidant in the absence of the light stabilizer. All the embodiments of the polymer compositions described herein likewise apply to the stabilized polymeric articles containing such compositions. Thus, in the stabilized polymer article that is resistant to discoloration, cracking, or crazing, the total amount of antioxidant can be from 0.001 to 5.0% by weight and the total amount of light stabilizer can be from 0.01 to 2.0% by weight, both based on the total weight of the polymer composition.

As described herein, the present disclosure includes at least the following embodiments:

A polymer composition for making a stabilized polymeric article that is resistant to at least one deleterious effect of discoloration, cracking, and/or crazing upon exposure to UV-C (190-280 nm) light, the polymer composition comprising:

i) an organic polymeric material; and

ii) a stabilizer composition comprising:
an antioxidant selected from the group consisting of hindered phenols, phosphites and phosphonites, and mixtures thereof; and
a light stabilizer selected from the group consisting of hindered amine light stabilizers (HALS), UV absorbers (UVA), hindered benzoates, and mixtures thereof,

even where barium compounds (such as barium salts) are absent from the stabilizer composition, and with the proviso that the HALS is not bis(2,2,6,6,-tetramethyl-4-piperidyl) sebacate (TINUVIN™ 770) alone.

In the same (i.e., foregoing) or other embodiment of the polymer composition, the at least one deleterious effect of reduced discoloration, cracking, and/or crazing upon exposure to UV-C light is associated with the use of the light stabilizer in combination with the antioxidant, even where barium compounds (such as barium salts) are absent from the stabilizer composition, compared to the antioxidant in the absence of the light stabilizer.

In any one of the foregoing or other embodiments of the polymer composition, the organic polymeric material includes at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene- acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

In any one of the foregoing or other embodiments of the polymer composition, the organic polymeric material includes at least one of (i) polyethylene, polypropylene, polyisobutylene, polybut-1-ene, or poly-4-methylpent-1-ene; (ii) polyisoprene or polybutadiene; (iii) cyclopentene or norbornene; (iv) optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (HDPE), low density polyethylene (LDPE), linear low density polyethylene (LLDPE), very low density polyethylene (VLDPE), or ultralow density polyethylene (ULDPE); (v) a thermoplastic olefin (TPO); or (vi) copolymers of at least one of mono-, di-, or cyclo-olefins.

In any one of the foregoing or other embodiments of the polymer composition of, the antioxidant is present at from 0.001 to 5.0%, preferably from 0.005 to 3.0%, and more preferably from 0.01 to 1.0% by weight, based on the total weight of the polymer composition.

In any one of the foregoing or other embodiments of the polymer composition, the light stabilizer is present at from 0.005 to 5.0% by weight, preferably from 0.01 to 2.0% by weight, based on the total weight of the polymer composition.

In any one of the foregoing or other embodiments of the polymer composition, the antioxidant comprises a hindered phenol having at least one group according to Formulae (IVa), (IVb), or (IVc):

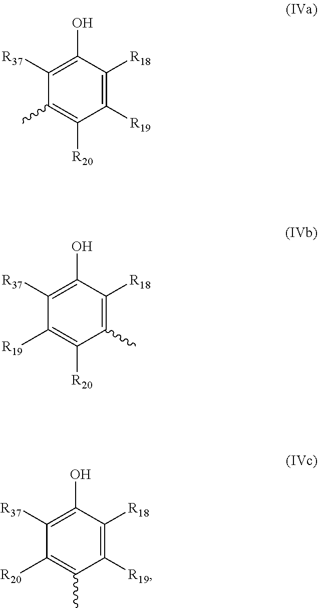

wherein:

“ [symbol] ” indicates the point of attachment (via a carbon-carbon single bond) of the molecular fragment to a parent compound;

R₁₈ of Formulae (IVa), (IVb), or (IVc) is hydrogen or C₁₋₁₂ hydrocarbyl;

each of R₁₉ and R₂₀ in Formulae (IVa), (IVb), or (IVc) is independently hydrogen or C₁-C₂₀ hydrocarbyl; and

R₃₇ of Formulae (IVa), (IVb), or (IVc) is C₁-C₁₂ hydrocarbyl.

In the same or other embodiment, R₁₈ and R₃₇ of Formulae (IVa), (IVb), or (IVc) are each independently methyl or tent-butyl.

In any of the same or other embodiments of the polymer composition, the hindered phenol includes at least one of:

1,3,5-tris(4-tert-butyl-3-hydroxy-2,6-dimethylbenzyl)-1,3,5-triazine-2,4,6-(1H,3H,5H)-trione (CYANOX™ 1790),

1,3,5-tris(3,5-di-tert-butyl-4-hydroxybenzyl)-1,3,5-triazine-2,4,6-(1H,3H,5H)-trione (IRGANOX™ 3114),

1,1,3-tris(2′-methyl-4′-hydroxy-5′-tert-butylphenyl)butane,

triethylene glycol bis[3-(3-tert-butyl-4-hydroxy-5-methylphenyl)propionate],

4,4′-thiobis(2-tert-butyl-5-methylphenol),

2,2′-thiodi ethylene bis[3-(3-tert-butyl-4-hydroxyl-5-methylphenyl)propionate],

octadecyl 3-(3-tert-butyl-4-hydroxy-5-methylphenyl)propionate,

pentaerythritol (3-tert-butyl-4-hydroxy-5-methylphenyl)propionate,

N,N′-hexamethylene bis[3-(3-tert-butyl-4-hydroxy-5-methylphenyl)propionamide],

di(4-tert-butyl-3-hydroxy-2,6-dimethylbenzyl)thiodipropionate,

pentaerythritol tetrakis(3-(3,5-di-tert-butyl-4-hydroxyphenyl)propionate) (IRGANOX™ 1010),

octadecyl 3-(3,5-di-tert-butyl-4-hydroxyphenyl)propionate (IRGANOX™ 1076), or

N,N′-bis(3,5-di-tert-butyl-4-hydroxylphenyl propionyl)hydrazine (IRGANOX™ 1024).

In any of the same or other embodiments of the polymer composition, the hindered phenol includes at least one of pentaerythritol tetrakis(3-(3,5-di-tert-butyl-4-hydroxyphenyl)propionate) (IRGANOX™ 1010), octadecyl 3-(3,5-di-tert-butyl-4-hydroxyphenyl)propionate (IRGANOX™ 1076), 1,3,5-tris(3,5-di-tert-butyl-4-hydroxybenzyl)-1,3,5-triazine-2,4,6-(1H,3H,5H)-trione (IRGANOX™ 3114), or N,N′-bis(3,5-di-tert-butyl-4-hydroxylphenyl propionyl)hydrazine (IRGANOX™ 1024).

In any of the same or other embodiments of the polymer composition, the antioxidant comprises the phosphite or phosphonite, and the phosphite or phosphonite includes at least one of:

i) a compound according to any of Formulae (1) to (7):

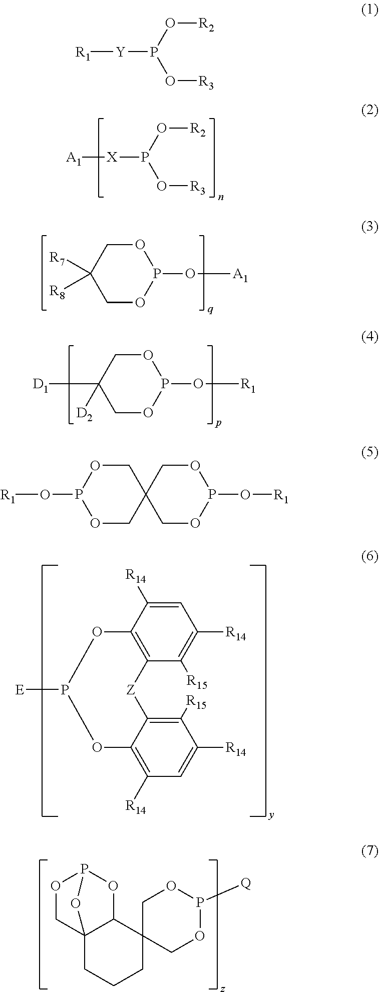

wherein:

the indices are integral and n is 2, 3 or 4; p is 1 or 2; q is 2 or 3; y is 1, 2 or 3; and z is 1 to 6;

A₁, if n or q is 2, is C₂-C₁₈ alkylene; C₂-C₁₂ alkylene interrupted by oxygen, sulfur or —NR₄—, a radical of the formulae:

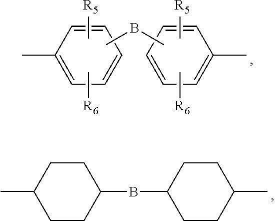

or phenylene;

A₁, if n or q is 3, is a divalent radical of the formula —CᵣH₂ᵣ₋₁—, wherein r is an integer from 4 to 12;

A₁, if n is 4, is

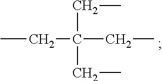

B is a direct bond, —CH₂—, —CHR₄—, —CR₁R₄—, sulfur, C₅-C₇ cycloalkylidene, or cyclohexylidene which is substituted by from 1 to 4 C₁-C₄ alkyl radicals in position 3, 4 and/or 5;

D₁, if p is 1, is C₁-C₄ alkyl and, if p is 2, is —CH₂OCH₂—;

D₂ is C₁-C₄ alkyl;

E, if y is 1, is C₁-C₁₈ alkyl, —OR₁ or halogen;

E, if y is 2, is —O-A₂-O—, wherein A₂ is as defined for A₁ when n is 2;

E, if y is 3, is a radical of the formula R₄C(CH₂O)₃ or N(CH₂CH₂O—)₃;

Q is the radical of an at least z-valent mono- or poly-alcohol or phenol, this radical being attached via the oxygen atom of the OH group of the mono- or poly-alcohol or phenol to the phosphorus atom;

R₁, R₂ and R₃ are each independently C₁-C₁₈ alkyl which is unsubstituted or substituted by halogen, —COOR₄, —CN or —CONR₄R₄; C₂-C₁₈ alkyl interrupted by oxygen, sulfur or —NR₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula

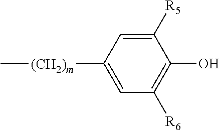

in which m is an integer from the range 3 to 6;

R₄ is hydrogen, C₁-C₈ alkyl, C₅-C₁₂ cycloalkyl or C₇-C₉ phenylalkyl;

R₅ and R₆ are each independently hydrogen, C₁-C₈ alkyl or C₅-C₆ cycloalkyl,

R₇ and R₈, if q is 2, are each independently C₁-C₄ alkyl or together are a 2,3-dehydropentamethylene radical; and R₇ and R₈, if q is 3, are each methyl;

each instance of R₁₄ is independently chosen from hydrogen, C₁-C₉ alkyl or cyclohexyl;

each instance of R₁₅ is independently hydrogen or methyl;

X and Y are each a direct bond or oxygen;

Z is a direct bond, methylene, —C(R₁₆)₂—or sulfur, and

R₁₆ is C₁-C₈ alkyl; or

ii) a trisarylphosphite according to Formula 8:

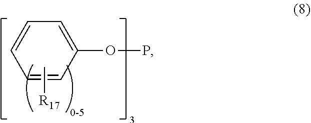

wherein:

R₁₇ is a substituent present at from 0 to 5 instances of the aromatic ring of Formula 8 and in each instance is independently C₁-C₂₀ alkyl, C₃-C₂₀ cycloalkyl, C₄-C₂₀ alkyl cycloalkyl, C₆-C₁₀ aryl, or C₇-C₂₀ alkylaryl.

In the same or other embodiments of the polymer composition, the phosphite or phosphonite includes at least one of:

triphenyl phosphite,

diphenyl alkyl phosphites,

phenyl dialkyl phosphites,

trilauryl phosphite,

trioctadecyl phosphite,

distearyl pentaerythritol phosphite,

tris(2,4-di-tert-butylphenyl) phosphite (IRGAFOS™ 168),

tris(4-nonylphenyl) phosphite,

a compound of Formulae (A), (B), (C), (D), (E), (F), (G), (H), (J), (K), or (L):

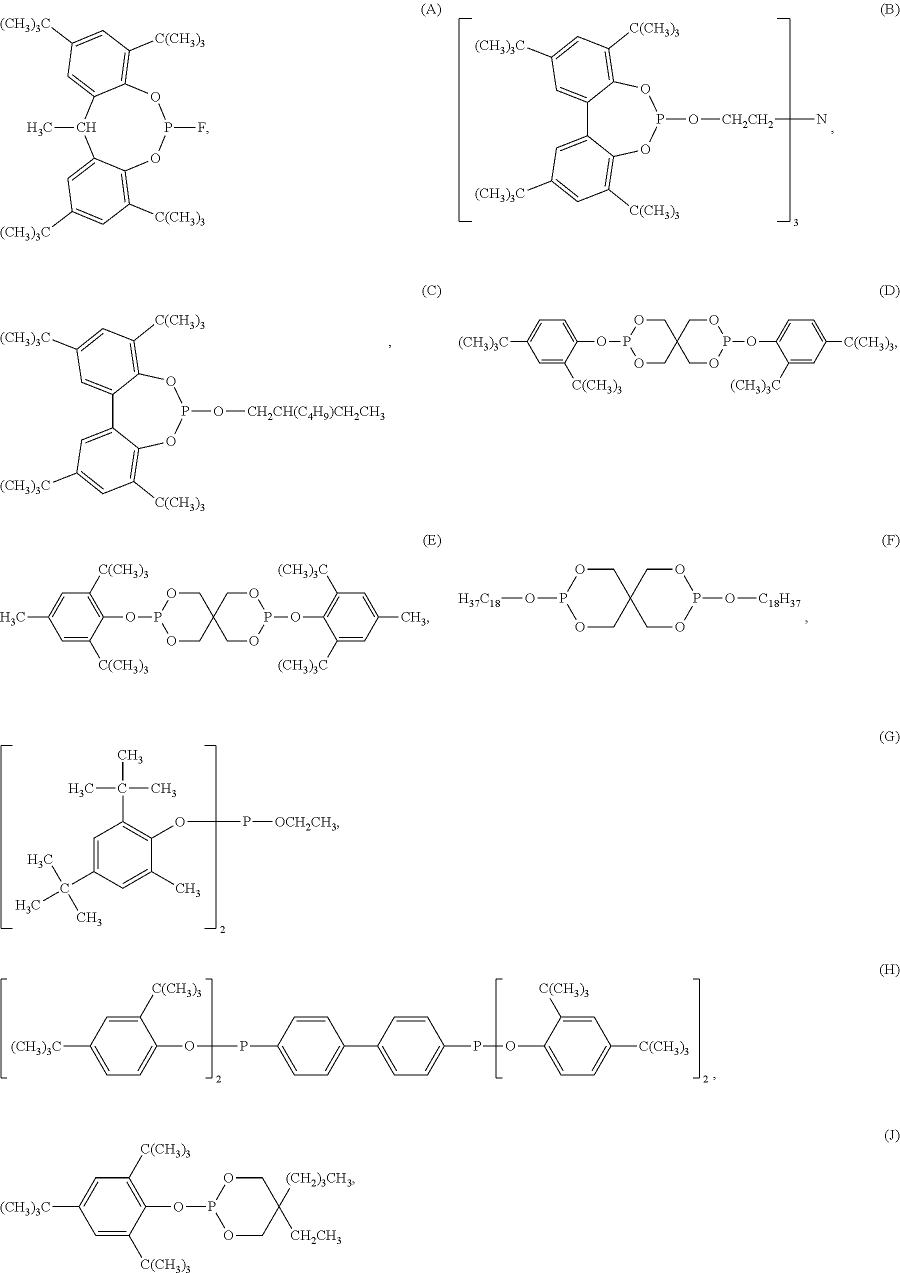

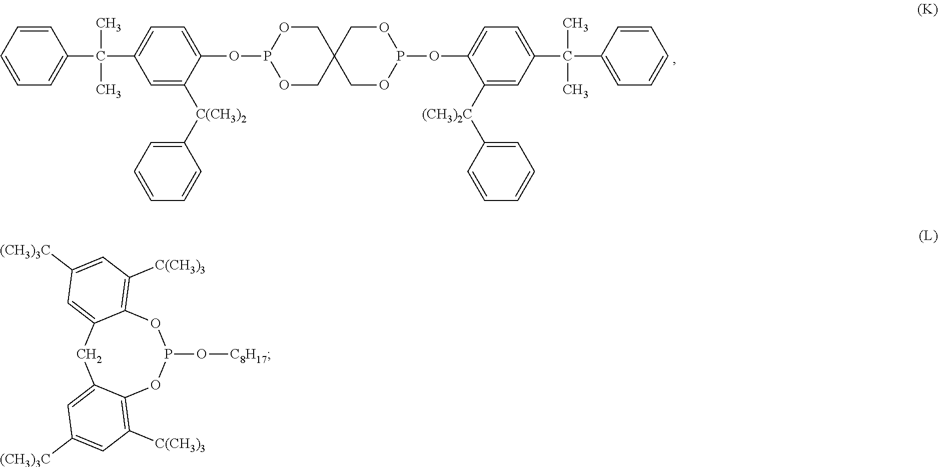

2-butyl-2-ethyl-1,3-propanediol 2,4,6-tri-tert-butylphenol phosphite,

bis(2,6-di-tert-butyl-4-methlphenyl) pentaerythritol diphosphite,

2-butyl-2-ethyl-1,3-propanediol 2,4-di-cumylphenol phosphite,

2-butyl-2-ethyl-1,3-propanediol 4-methyl-2,6-di-tert-butylphenol phosphite, or

bis(2,4,6-tri-tert-butyl-phenyl) pentaerythritol diphosphate.

In the same or other embodiments of the polymer composition, the phosphite or phosphonite includes at least one of tris(2,4-di-tert-butylphenyl)phosphite (IRGAFOS™ 168), triphenyl phosphite, tris(4-nonylphenyl) phosphite, bis(2,4-dicumylphenyl)pentaerythritol diphosphite (DOVERPHOS™ S9228), or tetrakis(2,4-di-tert-butylphenyl)-4,4′-biphenylene-diphosphonite (IRGAFOS™ P-EPQ).

In any of the same or other embodiments of the polymer composition, the light stabilizer comprises a hindered amine light stabilizer (HALS) comprising at least one functional group according to Formula (II):

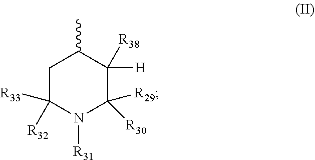

wherein:
R₃₁ is hydrogen, OH, C₁-C₂₀ hydrocarbyl, —CH₂CN, C₁-C₁₂ acyl, or C₁-C₁₈ alkoxy;
R₃₈ is hydrogen or C₁-C₈ hydrocarbyl; and
R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or

at least one functional group according to Formula (IIa):

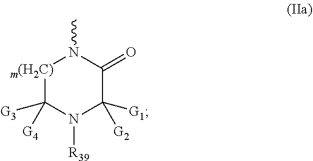

wherein:

m is an integer from 1 to 2;

R₃₉ is hydrogen, OH, C₁-C₂₀ hydrocarbyl, —CH₂CN, C₁-C₁₂ acyl, or C₁-C₁₈ alkoxy; and

G₁-G₄ are each independently C₁-C₂₀ hydrocarbyl.

In the same or other embodiments of the polymer composition, the hindered amine light stabilizer (HALS) is at least one of:

bis(2,2,6,6-tetramethylpiperidin-4-yl) succinate;

bis(1,2,2,6,6-pentamethylpiperidin-4-yl) sebacate;

bis(1-octyloxy-2,2,6,6-tetramethylpiperidyl) succinate;

bis(1-octyloxy-2,2,6,6-tetramethylpiperidin-4-yl) sebacate (TINUVIN™ 123);

bis(1,2,2,6,6-pentamethylpiperidin-4-yl) n-butyl 3,5-di-tert-butyl-4-hydroxybenzylmalonate;

a condensate of 1-(2-hydroxyethyl)-2,2,6,6-tetramethyl-4-hydroxypiperidine and succinic acid (TINUVIN™ 622);

2,2,6,6-tetramethylpiperidin-4-yl stearate;

2,2,6,6-tetramethylpiperidin-4-yl dodecanate;

1,2,2,6,6-pentamethylpiperidin-4-yl stearate;

1,2,2,6,6-pentamethylpiperidin-4-yl dodecanate;

a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);

tris(2,2,6,6-tetramethylpiperidin-4-yl) nitrilotriacetate;

4-stearyloxy-2,2,6,6-tetramethylpiperidine;

a condensate of N,N′-bis(2,2,6,6-tetramethylpiperidin-4-yl)hexamethylenediamine and 4-morpholino-2,6-dichloro-1,3,5-triazine (CYASORB™ UV-3346);

a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);

a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);

a condensate of 2-chloro-4,6-bis(4-n-butylamino-1,2,2,6,6-pentamethylpiperidyl)-1,3,5-triazine and 1,2-bis-(3-aminopropylamino)ethane;

a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);

a mixture of 4-hexadecyloxy- and 4-stearyloxy-2,2,6,6-tetramethylpiperidine (CYASORB™ UV-3853);

a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine;

a condensate of 1,2-bis(3-aminopropylamino)ethane, 2,4,6-trichloro-1,3,5-triazine, and 4-butylamino-2,2,6,6-tetramethylpiperidine;

a condensate of N,N′-bis(2,2,6,6-tetramethylpiperidin-4-yl)hexamethylenediamine and 4-cyclohexylamino-2,6-dichloro-1,3,5-triazine;

tetrakis(2,2,6,6-tetramethylpiperidin-4-yl)-1,2,3,4-butanetetracarboxylate; tetrakis(1,2,2,6,6-pentamethylpiperidin-4-yl)-1,2,3,4-butanetetracarboxylate;

1,2,3,4-butanetetracarboxylic acid, 2,2,6,6-tetramethylpiperidinyl-4-yl tridecyl ester;

1,2,3,4-butanetetracarboxylic acid, 1,2,2,6,6-pentamethylpiperidin-4-yl tridecyl ester;

formamide, N,N′-1,6-hexanediylbis[N-(2,2,6,6-tetramethylpiperidin-4-yl) (UVINUL™ 4050);

a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);

a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371;

N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200);

TINUVIN™ XT-850/XT-855); or

N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

In any of the same or other embodiments of the polymer composition, the light stabilizer comprises a UV absorber that is at least one 2-(2′-hydroxyphenyl-s-triazine, 2-hydroxybenzophenone, 2-(2′-hydroxyphenyl)benzotriazole, or benzoxazinone.

In the same or other embodiments of the polymer composition, the light stabilizer comprises at least one 2-(2′-hydroxyphenyl)-s-triazine according to Formula (I):

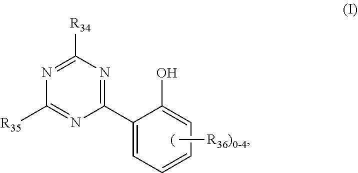

wherein each of R₃₄ and R₃₅ is independently a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl,

wherein the C₆-C₁₀ aryl group is optionally substituted at from 1 to 3 substitutable positions with at least one of OH, halogen, C₁-C₁₂ alkyl, C₁-C₁₂ alkoxy, C₁-₁₂ alkoxyester, C₂-₁₂ alkanoyl, or phenyl, wherein the phenyl is optionally substituted at from 1 to 3 substitutable positions with at least one of OH, halogen,C₁-₁₂ alkyl,C₁-₁₂ alkoxy,C₁-₁₂ alkoxyester, or C₂-₁₂ alkanoyl; and

each R₃₆ is independently OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

In the same or other embodiments of the polymer composition, the 2-(2′-hydroxyphenyl)-s-triazine includes at least one of:

4,6-diphenyl-2-(4-hexyloxy-2-hydroxyphenyl)-s-triazine (TINUVIN™ 1577),

4,6-bis-(2,4-dimethylphenyl)-2-(2-hydroxy-4-octyloxyphenyl)-s-triazine (CYASORB™ 1164),

2,4-bis[2-hydroxy-4-(2-hydroxy-4-(2-hydroxyethoxy)phenyl]-6-(2,4-dimethylphenyl)-s-triazine,

mixture of 4,6-bis(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),

4,6-bis(2,4-dimethylphenyl)-2-(2-hydroxy-4(3-(2-ethylhexyloxy)-2-hydroxypropoxy)-phenyl)-s-triazine (TINUVIN™ 405),

4,6-bis(2,4-dimethylphenyl)-2-(2-hydroxy-4(3-(2-ethylhexyloxy)-2-hydroxypropoxy)-phenyl)-s-triazine,

2,4-bis(2,4-dimethylphenyl)-6-[2-hydroxy-4-[(octyloxycarbonyl)ethylideneoxy]phenyl]-s-triazine (TINUVIN™ 479),

2,4-bis(4-biphenylyl)-6-[2-hydroxy-4-[(octyloxycarbonyl)ethylideneoxy]phenyl]-s-triazine,

2,4-bis(4-biphenylyl)-6-[2-hydroxy-4-(2-ethylhexyloxy)phenyl]-s-triazine (TINUVIN™ 1600),

2,4-bis(2-hydroxy-4-butyloxyphenyl)-6-(2,4-bis-butyloxyphenyl)-s-triazine (TRIAZINE™ 460),

2,4,6-tris[2-hydroxy-4-(3-sec-butyloxy-2-hydroxypropyloxy)-phenyl]-s-triazine, or

2,4,6-tris[2-hydroxy-4-[(octyloxycarbonyl)ethylideneoxy]phenyl]-s-triazine (TINUVIN™ 477).

In any of the same or other embodiments of the polymer composition, the light stabilizer comprises a 2-hydroxybenzophenone that includes at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-531), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

In any of the same or other embodiments of the polymer composition, the light stabilizer comprises a 2-(2′-hydroxyphenyl)benzotriazole that includes at least one of 2-(2′-hydroxy-5′-methylphenyl)b enzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVIN™ 1130), 2-[2′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, or 2-(5′-tert-butyl-2′-hydroxyphenyl)benzotriazole.

In any of the same or other embodiments of the polymer composition, the light stabilizer comprises a benzoxazinone that includes at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p- nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-0-methoxyphenyl-3,1-benzoxazin-4-one, 2-cyclohexyl-3,1-benzoxazin-4-one, 2p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6-or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

In any of the same or other embodiments of the polymer composition, the light stabilizer comprises a hindered benzoate according to Formula (VI):

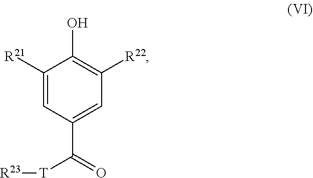

wherein:

each of R²¹ and R²² is independently a C₁₋C₁₂ alkyl;

T is O or NR²⁴, wherein R²⁴ is H or a C₁-C₃₀ hydrocarbyl; and

R²³ is H or a C₁-C₃₀ hydrocarbyl.

In the same or other embodiments of the polymer composition, the hindered benzoate includes at least one of 2,4-di-tert-butylphenyl 3,5-di-tert-butyl-4-hydroxybenzoate (TINUVIN™ 120), hexadecyl 3,5-di-tert-butyl-4-hydroxybenzoate (CYASORB™ UV-2908), octadecyl 3,5-di-tert-butyl-4-hydroxybenzoate, octyl 3,5-di-tert-butyl-4-hydroxybenzoate, decyl 3,5-di-tert-butyl-4-hydroxybenzoate, dodecyl 3,5-di-tert-butyl-4-hydroxybenzoate, tetradecyl 3,5-di-tert-butyl-4-hydroxybenzoate, behenylyl 3,5-di-tert-butyl-4-hydroxybenzoate, 2-methyl-4,6-di-tert-butylphenyl 3,5-di-tert-butyl-4-hydroxybenzoate, or butyl 3-[3-tert-butyl-4-(3,5-di-tert-butyl-4-hydroxybenzoyloxy)phenyl]propionate.

In any of the same or other embodiments, the polymer composition further comprises a thiosynergist that includes at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

In any of the same or other embodiments, the polymer composition further comprises an inorganic compound that includes at least one of titanium dioxide, barium sulfate, zinc oxide, or cerium(IV) oxide.

In any of the same or other embodiments of the polymer composition, the polymer composition is free of barium compounds.

The present invention also provides stabilized polymeric articles that are resistant to deleterious effects of at least one of discoloration, cracking, and/or crazing upon repeated or prolonged exposure to UV-C (190-280 nm) light comprising the polymer composition of any one of the foregoing embodiments described herein.

In the same or other embodiments of the stabilized polymeric article, the at least one deleterious effect of reduced discoloration, cracking, or crazing upon exposure to UV-C light is associated with the use of the light stabilizer in combination with the antioxidant, even where barium compounds (such as barium salts) are absent from the stabilizer composition, compared to the antioxidant in the absence of the light stabilizer.

Methods of making the stabilized polymeric articles of as described in any one of the embodiment herein are also provided by the invention, such methods comprising:

adding to the organic polymeric material a stabilizer composition comprising:

an antioxidant selected from the group consisting of hindered phenols, phosphites and phosphonites, and mixtures thereof; and

a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVIN™ 770) alone; and

shaping the organic polymeric material containing the stabilizer composition into the stabilized polymeric article.

Similarly, methods of stabilizing an organic polymeric material against the deleterious effects of repeated or prolonged exposure to UV-C (190-280 nm) light are also provided, such methods comprising adding to the organic polymeric material a stabilizer composition comprising:

an antioxidant selected from the group consisting of hindered phenols, phosphites and phosphonites, and mixtures thereof; and

a light stabilizer selected from the group consisting of hindered amine light stabilizers (HALS), UV absorbers (UVA), hindered benzoates, and mixtures thereof, even where barium compounds (such as barium salts) are absent from the stabilizer composition, and with the proviso that the HALS is not bis(2,2,6,6,-tetramethyl-4-piperidyl) sebacate (TINUVIN™ 770) alone;

wherein at least one deleterious effect of reduced discoloration or reduced cracking or crazing upon repeated or prolonged exposure to UV-C light is associated with the use of the light stabilizer in combination with the antioxidant compared to the antioxidant in the absence of the light stabilizer.

In the same or other embodiments for stabilizing an organic polymeric material against the deleterious effects of UV-C light, the total amount of antioxidant includes from 0.001 to 5.0% by weight and the total amount of light stabilizer includes from 0.01 to 2.0% by weight, both based on the total weight of the polymer composition.

### EXAMPLES

The following examples are provided to assist one skilled in the art to further understand certain embodiments defined herein. These examples are intended for illustration purposes and are not to be construed as limiting the scope of the various embodiments as defined by the claims.

The performances of various individual additive materials as well as their specific combinations are evaluated in regard to protecting polymers from UV-C induced discoloration and photodegradation. Polypropylene homopolymer (PRO-FAX™ 6301 NT) from LyondellBasell is chosen as the polymer matrix for the weathering studies in the examples. Information regarding the suppliers, commercial names, and chemical names of various additive materials in formulating the examples is listed in Table 1. In some cases, these same chemicals may be available from other suppliers under different trade names. All additive materials are used as received.

TABLE 1
Additive Types, Trade names, Chemical Names, and Suppliers of Additives

| Additive Type | Trade Name (Source) | Chemical Name |
|---|---|---|
| Antioxidant | CYANOX ™ 2777 | 1:2 Blend of 1,3,5-tris(4-tert-butyl-3- |
| | (Solvay) | hydroxy-2,6-dimethyl benzyl)-1,3,5- |
| | | triazine-2,46-(1H,3H,5H)-trione and |
| | | tris(2,4,di-tert-butylphenyl)phosphite |
| Antioxidant | CYANOX ™ 1790 | Tris(4-tert-butyl-3-hydroxy-2,6- |
| | (Solvay) | dimethylbenzyl) isocyanurate |
| Antioxidant | IRGANOX ™ 1010 | Pentaerythritol tetrakis(3-(3,5-di-tert- |
| | (BASF) | butyl-4-hydroxyphenyl)propionate) |
| Antioxidant | IRGANOX ™ 1076 | Octadecyl 3-(3,5-di-tert-buty1-4- |
| | (BASF) | hydroxyphenyl)propionate |
| Antioxidant | IRGAFOS ™ 168 | Tris(2,4-di-tert-butylphenyl) |
| | (BASF) | phosphite |
| Antioxidant; | IRGANOX ™ 1024 | N,N′-Bis(3,5-di-tert-buty1-4- |
| Metal deactivator | (BASF) | hydroxyl-phenyl propionyl)hydrazine |
| Antioxidant | WESTON ™ 618 | Distearyl Pentaerythritol Diphosphite |
| | (Addivant) | |
| UV Absorber | CYASORB ™ UV-24 | 2,2′-Dihydroxy-4- |
| | (Solvay) | methoxybenzophenone |
| UV Absorber | CYASORB ™ UV-9 | (2-Hydroxy-4-methoxyphenyl)- |
| | (Solvay) | phenylmethanone |
| UV Absorber | CYASORB ™ UV-531 | 2-Hydroxy-4- |
| | (Solvay) | (octyloxy)benzophenone |
| UV Absorber | CYASORB ™ UV-5411 | 2-(2-Hydroxy-5-tert-octylphenyl)- |
| | (Solvay) | benzotriazole |
| UVAbsorber | TINUVIN ™ 326 | Phenol, 2-(5-chloro-2H-benzotriazol- |
| | (BASF) | 2-y1)-6-(tert-butyl)-4-methyl |
| UV Absorber | CYASORB ™ UV-1164 | 2-(4,6-Bis-(2,4-dimethylphenyl)- |
| | (Solvay) | 1,3,5-triazin-2-yl)-5-(octyloxy)-phenol |
| UV Absorber | TINUVIN ™ 1577 | Phenol, 2-(4,6-diphenyl-1,3,5-triazin- |
| | (BASF) | 2-yl)-5-hexyloxy |
| Hindered | CYASORB ™ UV-2908 | 3,5-Di-tert-buty1-4-hydroxybenzoic |
| Benzoate | (Solvay) | acid, hexadecyl ester |
| Hindered | TINUVIN ™ 120 | Benzoic acid, 3,5-(1, 1- |
| Benzoate | (BASF) | dimethylethyl)-, 2,4-bis (1,1- |
| | | dimethyethyl) phenyl ester |
| Hindered Amine | CYASORB ™ UV-3346 | Poly [(6-morpholino-s-triazine-2,4- |
| Light Stabilizer | (Solvay) | diyl)[2,2,6,6-tetramethyl-4-piperidyl) |
| | | imino]-hexamethylene [(2,2,6,6- |
| | | tetramethyl-4-piperidyl) imino]] |
| Hindered Amine | CYASORB ™ UV-3853PP5 | 4-Piperido1-2,2,6,6-tetramethyl RPW |
| Light Stabilizer | (50% active) | stearin; 2,2,6,6-tetramethyl-4- |
| | (Solvay) | piperidinyl stearate (fatty esters |
| | | mixture) |
| Hindered Amine | CHIMMASORB ™ 2020 | 1,6-Hexanediamine, N,N′-bis(2,2,6,6- |
| Light Stabilizer | (BASF) | tetramethyl-4-piperidinyl)-polymer |
| | | with 2,4,6-trichloro-1,3,5-triazine, |
| | | reaction products with N-butyl-1- |
| | | butanamine and N-butyl-2,2,6,6- |
| | | tetramethyl-4-piperidinamine |
| Hindered Amine | TINUVIN ™ 622 | Butanedioc acid, dimethyl ester, |
| Light Stabilizer | (BASF) | polymer with 4-hydroxy-2,2,6,6- |
| | | tetramethyl-1-piperidine ethanol |
| Hindered Amine | TINUVIN ™ 770 | Bis(2,2,6,6,-tetramethyl-4- |
| Light Stabilizer | (BASF) | piperidyl)sebacate |

The general procedure for the preparation of plaques containing the additives is as follows. 1,000 Grams powder mixtures of each formulation are prepared by dry blending the additives with the polypropylene resin. The mixtures are then compounded at 230° C. with a Werner & Pfleiderer twin screw extruder. After extrusion, standard rectangular plaques (2×2.5×0.125 inch) are injection molded at 200° C. into rectangular plaques with an Auburg injection molding machine.

For UV-C weathering studies, a UV-C weathering apparatus was developed and assembled in-house. The apparatus contains two low-pressure, narrow band UV-C lamps (254 nm) with an average irradiance of ca. 1200 μW/cm² (at 254 nm) at the plaque surface as well as an automatic fan controller in order to maintain the test temperature below 40° C. During the UV-C weathering tests, plaques are placed inside the apparatus and repositioned frequently to ensure all samples received an equal amount of radiant exposure.

The changes in color (delta E) and in Yellowness Index (delta YI) of the plaque surface after UV-C exposure is used to evaluate surface discoloration. Both the color and YI measurements are conducted using an X-Rite Color i7 spectrophotometer using the Hunter L, a, b color scale (for color). Delta E is measured according to ASTM D2244-16 and delta YI is measured according to ASTM E313-20. Delta E is calculated by subtracting the initial color reading (time=0 hour) from the color reading after a specified number of hours of UV-C exposure. Delta YI is calculated by subtracting the initial YI reading (time=0 hour) from the YI reading after a specified number of hours of UV-C exposure. For example, the number of hours can be 24, 42, or 250. 24 Hours is a convenient time scale.

The development of cracks and/or crazing on the polymeric article surface after UV-C exposure is used to evaluate photodegradation. The polypropylene plaques are examined both visually and with a Leica S9i digital stereo microscope (at 20× magnification) for cracks or crazing at each testing interval. Pictures are taken using the camera integrated into the microscope.

### Example 1

### UV-C Weathering Performance (Delta E and Delta Y1) of Polypropylene Containing a Phosphite and Other Additives

TABLE 2
UV-C Weathering Performance of Polypropylene Containing
Phosphite and Other Additives

| | | YI | Delta | Delta |
|---|---|---|---|---|
| | | (0 | YI (24 | E (24 |
| Sample | Formulation | hours) | hours) | hours) |
| 2-1 | 100% Polypropylene | 9.72 | 0.35 | 0.27 |
| 2-2 | 99.85% Polypropylene + | 11.95 | 17.38 | 8.43 |
| | 0.15% IRGAFOS ™ 168 | | | |
| 2-3 | 99.45% Polypropylene + | 12.35 | 2.30 | 1.21 |
| | 0.40% CYASORB ™ UV-1164 + | | | |
| | 0.15% IRGAFOS ™ 168 | | | |
| 2-4 | 99.45% Polypropylene + | 9.86 | 2.62 | 1.29 |
| | 0.40% CYASORB ™ UV-5411 + | | | |
| | 0.15% IRGAFOS ™ 168 | | | |
| 2-5 | 99.45% Polypropylene + | 14.14 | 1.33 | 0.67 |
| | 0.40% CYASORB ™ UV-531 + | | | |
| | 0.15% IRGAFOS ™ 168 | | | |
| 2-6 | 99.45% Polypropylene + | 9.21 | 4.76 | 2.44 |
| | 0.40% CYASORB ™ UV-3346 + | | | |
| | 0.15% IRGAFOS ™ 168 | | | |
| 2-7 | 99.45% Polypropylene + | 9.11 | 13.48 | 6.61 |
| | 0.40% TINUVIN ™ 770 + | | | |
| | 0.15% IRGAFOS ™ 168 | | | |
| 2-8 | 99.45% Polypropylene + | 8.92 | 6.77 | 3.61 |
| | 0.40% CYASORB ™ UV-2908 + | | | |
| | 0.15% IRGAFOS ™ 168 | | | |

The data in Table 2 demonstrates that polypropylene formulated with a common phosphite antioxidant experiences significant discoloration upon UV-C exposure compared to neat, unstabilized polypropylene. (Compare Sample 2-2 with Sample 2-1.) However, certain light stabilizers in combination with the phosphite mitigate discoloration upon UV-C exposure, as demonstrated by lower delta Y1 and delta E values presented in Table 2 (Samples 2-2 to 2-8).

### Example 2

### UV-C Weathering Performance (Delta E and Delta Y1) of Polypropylene Containing a Hindered Phenol and Other Additives

TABLE 3
UV-C Weathering Performance of Polypropylene Containing a
Hindered Phenol and Other Phosphites

| | | YI | Delta | Delta |
|---|---|---|---|---|
| | | (0 | YI (24 | E (24 |
| Sample | Formulation | hours) | hours) | hours) |
| 3-1 | 100% Polypropylene | 9.72 | 0.35 | 0.27 |
| 3-2 | 99.90% Polypropylene + | 9.28 | 6.91 | 3.76 |
| | 0.10% IRGANOX ™ 1010 | | | |
| 3-3 | 99.50% Polypropylene + | 12.17 | 0.14 | 0.13 |
| | 0.40% CYASORB ™ UV-1164 + | | | |
| | 0.10% IRGANOX ™ 1010 | | | |
| 3-4 | 99.50% Polypropylene + | 11.62 | 6.51 | 3.25 |
| | 0.40% CYASORB ™ UV-5411 + | | | |
| | 0.10% IRGANOX ™ 1010 | | | |
| 3-5 | 99.50% Polypropylene + | 15.29 | 1.08 | 0.55 |
| | 0.40% CYASORB ™ UV-531+ | | | |
| | 0.10% IRGANOX ™ 1010 | | | |
| 3-6 | 99.50% Polypropylene + | 10.55 | 9.33 | 4.86 |
| | 0.40% CYASORB ™ UV-3346 + | | | |
| | 0.10% IRGANOX ™ 1010 | | | |
| 3-7 | 99.50% Polypropylene + | 10.23 | 2.98 | 1.63 |
| | 0.40% CYASORB ™ UV-2908 + | | | |
| | 0.10% IRGANOX ™ 1010 | | | |

The data in Table 3 demonstrates that polypropylene formulated with a common hindered phenol experiences significant discoloration upon UV-C exposure. (Compare Sample 3-2 with Sample 3-1.) However, certain light stabilizers in combination with the hindered phenol mitigate discoloration upon UV-C exposure, as demonstrated by the lower delta Y1 and delta E values presented in Table 3 (Samples 3-3 to 3-7).

### Example 3

### UV-C Weathering Performance (Delta E and Delta Y1) of Polypropylene Containing a Phosphite and Other Additives

TABLE 4
UV-C Weathering Performance of Polypropylene Containing a
Phosphite and Other Additives

| | | YI | Delta | Delta |
|---|---|---|---|---|
| | | (0 | YI (24 | E (24 |
| Sample | Formulation | hours) | hours) | hours) |
| 4-1 | 100% Polypropylene | 9.72 | 0.35 | 0.27 |
| 4-2 | 99.85% Polypropylene + | 11.95 | 17.38 | 8.43 |
| | 0.15% IRGAFOS ™ 168 | | | |
| 4-3 | 99.05% Polypropylene + | 11.36 | 1.14 | 0.61 |
| | 0.40% CYASORB ™ UV-1164 + | | | |
| | 0.40% CYASORB ™ UV-3346 + | | | |
| | 0.15% IRGAFOS ™ 168 | | | |
| 4-4 | 99.05% Polypropylene + | 10.95 | 1.97 | 1.03 |
| | 0.40% CYASORB ™ UV-1164 + | | | |
| | 0.40% TINUVIN ™ 770 + | | | |
| | 0.15% IRGAFOS ™ 168 | | | |
| 4-5 | 99.25% Polypropylene + | 10.36 | 4.05 | 2.22 |
| | 0.20% CYASORB ™ UV-1164 + | | | |
| | 0.20% CYASORB ™ UV-3346 + | | | |
| | 0.20% CYASORB ™ UV-2908 + | | | |
| | 0.15% IRGAFOS ™ 168 | | | |
| 4-6 | 99.25% Polypropylene + | 9.90 | 11.55 | 6.22 |
| | 0.20% CYASORB ™ UV-1164 + | | | |
| | 0.20% TINUVIN ™ 770 + | | | |
| | 0.20% CYASORB ™ UV-2908 + | | | |
| | 0.15% IRGAFOS ™ 168 | | | |

The data in Table 4 demonstrates that polypropylene formulated with a common phosphite antioxidant experiences significant discoloration upon UV-C exposure. (Compare Sample 4-2 with Sample 4-1.) However certain combinations of UV absorbers, hindered amine light stabilizers, and hindered benzoates used in combination with the phosphite mitigate discoloration upon UV-C exposure, as demonstrated by lower delta Y1 and delta E values presented in Table 4 (Samples 4-3 to 4-6).

### Example 4

### UV-C Weathering Performance (Delta E and Delta Y1) of Polypropylene Containing a Hindered Phenol and Other Additives

TABLE 5
UV-C Weathering Performance of Polypropylene Containing a
Hindered Phenol and Other Additives

| | | YI | Delta | Delta |
|---|---|---|---|---|
| | | (0 | YI (24 | E (24 |
| Sample | Formulation | hours) | hours) | hours) |
| 5-1 | 100% Polypropylene | 9.72 | 0.35 | 0.27 |
| 5-2 | 99.90% Polypropylene + | 9.28 | 6.91 | 3.76 |
| | 0.10% IRGANOX ™ 1010 | | | |
| 5-3 | 99.10% Polypropylene + | 12.71 | 1.94 | 1.01 |
| | 0.40% CYASORB ™ UV-1164 + | | | |
| | 0.40% CYASORB ™ UV-3346 + | | | |
| | 0.10% IRGANOX ™ 1010 | | | |
| 5-4 | 99.10% Polypropylene + | 13.27 | 2.99 | 1.60 |
| | 0.40% CYASORB ™ UV-1164 + | | | |
| | 0.40% TINUVIN ™ 770 + | | | |
| | 0.10% IRGANOX ™ 1010 | | | |
| 5-5 | 99.30% Polypropylene + | 11.78 | 4.45 | 2.42 |
| | 0.20% CYASORB ™ UV-1164 + | | | |
| | 0.20% CYASORB ™ UV-3346 + | | | |
| | 0.20% CYASORB ™ UV-2908 + | | | |
| | 0.10% IRGANOX ™ 1010 | | | |
| 5-6 | 99.30% Polypropylene + | 12.19 | 5.06 | 2.74 |
| | 0.20% CYASORB ™ UV-1164 + | | | |
| | 0.20% TINUVIN ™ 770 + | | | |
| | 0.20% CYASORB ™ UV-2908 + | | | |
| | 0.10% IRGANOX ™ 1010 | | | |

The data in Table 5 demonstrates that polypropylene formulated with a common hindered phenol antioxidant experiences significant discoloration upon UV-C exposure. (Compare Sample 5-2 with Sample 5-1.) However, certain combinations of UV absorbers, hindered amine light stabilizers, and hindered benzoates used in combination with the hindered phenol mitigate discoloration upon UV-C exposure, as demonstrated by lower delta Y1 and delta E values presented in Table 5. (Samples 5-3 to 5-6)

### Example 5

### UV-C Weathering Performance (Delta E, Delta YI, and Cracking/Crazing) of Polypropylene Containing Antioxidants Only

TABLE 6
UV-C Weathering Performance of Polypropylene Containing Antioxidants Only

| | | YI | Delta YI | Delta E | Cracks/Crazing |
|---|---|---|---|---|---|
| Sample | Formulation | (0 h) | (250 h) | (250 h) | (250 h) |
| 6-1 | 100% Polypropylene | 10.37 | 4.17 | 2.46 | Significant |
| | | | | | cracks/crazing (as |
| | | | | | shown in FIG. 1A) |
| 6-2 | 99.92% Polypropylene + | 12.51 | 15.15 | 7.39 | Some cracks/crazing |
| | 0.08% CYANOX ™ 2777 | | | | (as shown in FIG. 1B) |
| 6-3 | 99.92% Polypropylene + | 10.96 | 8.49 | 4.65 | No cracks/crazing |
| | 0.08% IRGANOX ™ 1010 | | | | |
| 6-4 | 99.92% Polypropylene + | 11.07 | 2.34 | 1.55 | Small cracks/crazing |
| | 0.08% JRGANOX ™ 1076 | | | | (as shown in FIG. 1C) |

The data for Sample 6-1 in Table 6 demonstrate that unstabilized polypropylene undergoes severe photodegradation upon UV-C irradiation, as evidenced by the development of significant surface cracks and/or crazing as shown in FIG. 1A. Samples 6-2 to 6-4 demonstrate that polypropylene containing antioxidants only (either hindered phenol alone, or a combination of hindered phenol and phosphite) undergoes severe surface discoloration (as evidenced by delta E and delta YI results), photodegradation (as evidenced by surface cracks/crazing as shown in Table 6 and FIG. 1B and FIG. 1C), or a combination of both discoloration and photodegradation.

### Example 6

### UV-C Weathering Performance (Delta E, Delta YI, and Cracking/Crazing) of Polypropylene Containing a Combination of Antioxidants and Hindered Amine Light Stabilizers

TABLE 7
UV-C Weathering Performance of Polypropylene Containing a Combination of
Antioxidants and Hindered Amine Light Stabilizers.

| | | YI | Delta YI | Delta E | Cracks/Crazing |
|---|---|---|---|---|---|
| Sample | Formulation | (0 h) | (250 h) | (250 h) | (250 h) |
| 7-1 | 100% Polypropylene | 10.37 | 4.17 | 2.46 | Significant |
| | | | | | cracks/crazing |
| 7-2 | 99.92% Polypropylene + | 12.51 | 15.15 | 7.39 | Some |
| | 0.08% CYANOX ™ 2777 | | | | cracks/crazing |
| 7-3 | 99.12% Polypropylene + | 11.64 | 13.95 | 6.88 | Some |
| | 0.08% CYANOX ™ 2777 + | | | | cracks/crazing |
| | 0.80% CYASORB ™ UV-3346 | | | | |
| 7-4 | 99.12% Polypropylene + | 11.44 | 13.74 | 6.71 | Some |
| | 0.08% CYANOX ™ 2777 + | | | | cracks/crazing |
| | 0.80% CHIMASSORB ™ 2020 | | | | |
| 7-5 | 98.32% Polypropylene + | 10.84 | 28.47 | 13.03 | No cracks/ |
| | 0.08% CYANOX ™ 2777 + | | | | crazing |
| | 1.6% CYASORB ™ UV-3853PP5 | | | | |
| 7-6 | 99.12% Polypropylene + | 12.58 | 25.66 | 11.71 | No cracks/ |
| | 0.08% CYANOX ™ 2777 + | | | | crazing |
| | 0.80% TINUVIN ™622 | | | | |
| 7-7 | 99.12% Polypropylene + | 11.01 | 27.68 | 12.74 | No cracks/ |
| | 0.08% CYANOX ™ 2777 + | | | | crazing |
| | 0.80% CYASORB ™ 770 | | | | |

Samples 7-3 and 7-4 demonstrate that polypropylene containing both antioxidants and hindered amine light stabilizers show less discoloration upon UV-C irradiation than Sample 7-2, which contains antioxidants only, as evidenced by the Delta E and Delta Y1 results shown in Table 7. Samples 7-5, 7-6, and 7-7 demonstrate that polypropylene containing both antioxidants and hindered amine light stabilizers show less surface photodegradation after UV-C irradiation than both unstabilized polypropylene (Sample 7-1) and polypropylene containing antioxidants only (Sample 7-2), as evidenced by the surface cracks/crazing observations in Table 7.

### Example 7

### UV-C Weathering Performance (Delta E, Delta Y1, and Cracking/Crazing) of Polypropylene Containing a Combination of Antioxidants and UV Absorbers

TABLE 8
UV-C Weathering Performance of Polypropylene Containing a Combination of Antioxidants
and UV Absorbers

| | | Delta E | YI | Delta YI | Cracks/Crazing |
|---|---|---|---|---|---|
| Sample | Formulation | (250 h) | (0 h) | (250 h) | (250 h) |
| 8-1 | 100% Polypropylene | 2.46 | 10.37 | 4.17 | Significant |
| | | | | | cracks/crazing |
| 8-2 | 99.92% Polypropylene + | 7.39 | 12.51 | 15.15 | Some |
| | 0.08% CYANOX ™ 2777 | | | | cracks/crazing |
| 8-3 | 99.12% Polypropylene + | 3.6 | 65.12 | 3.18 | No |
| | 0.08% CYANOX ™ 2777 + | | | | cracks/crazing |
| | 0.80% CYASORB ™ UV-24 | | | | |
| 8-4 | 99.12% Polypropylene + | 1.5 | 42.47 | 3.66 | No |
| | 0.08% CYANOX ™ 2777 + | | | | cracks/crazing |
| | 0.80% CYASORB ™ UV-9 | | | | |
| 8-5 | 99.12% Polypropylene + | 0.73 | 24.81 | 1.52 | No |
| | 0.08% CYANOX ™ 2777 + | | | | cracks/crazing |
| | 0.80% CYASORB ™ UV-531 | | | | |
| 8-6 | 99.12% Polypropylene + | 1.10 | 15.71 | 2.74 | No |
| | 0.08% CYANOX ™ 2777 + | | | | cracks/crazing |
| | 0.80% CYASORB ™ UV-5411 | | | | |
| 8-7 | 99.12% Polypropylene + | 1.75 | 18.46 | 4.12 | No |
| | 0.08% CYANOX ™ 2777 + | | | | cracks/crazing |
| | 0.80% TINUVIN ™ 326 | | | | |
| 8-8 | 99.12% Polypropylene + | 0.88 | 19.74 | −1.29 | Small |
| | 0.08% CYANOXV ™ 2777 + | | | | cracks/crazing |
| | 0.80% CYASORB ™ UV-1164 | | | | |
| 8-9 | 99.12% Polypropylene + | 0.67 | 20.48 | −1.7 | No |
| | 0.08% CYANOX ™ 2777 + | | | | cracks/crazing |
| | 0.80% TINUVIN ™ 1577 | | | | |

Samples 8-3 to 8-9 demonstrate that polypropylene containing both antioxidant and UV absorbers (benzophenone, benzotriazole, or triazine) show less discoloration upon UV-C irradiation than both unstabilized polypropylene (Sample 8-1) and polypropylene containing antioxidants only (Sample 8-2), as evidenced by the Delta E and Delta Y1 results presented in Table 8. Additionally, formulations 8-3 to 8-9 demonstrate that polypropylene containing both antioxidant and UV absorber shows less photodegradation than both unstabilized polypropylene (Sample 8-1) and polypropylene containing antioxidants only (Sample 8-2), as evidenced by the surface cracks/crazing observations.

### Example 8

### UV-C Weathering Performance (Delta E, Delta Y1, and Cracking/Crazing) of Polypropylene Containing a Combination of Antioxidants and Hindered Benzoates

TABLE 9
UV-C Weathering Performance of Polypropylene Stabilized by a Combination of Antioxidants
and Hindered Benzoates

| | | YI | Delta YI | Delta E | Cracks/Crazing |
|---|---|---|---|---|---|
| Sample | Formulation | (0 h) | (250 h) | (250 h) | (250 h) |
| 9-1 | 100% Polypropylene | 10.37 | 4.17 | 2.46 | Significant |
| | | | | | cracks/crazing |
| 9-2 | 99.92% Polypropylene + | 12.51 | 15.15 | 7.39 | Some |
| | 0.08% CYANOX ™ 2777 | | | | cracks/crazing |
| 9-3 | 99.12% Polypropylene + | 11.76 | 12.23 | 5.93 | Some |
| | 0.08% CYANOX ™ 2777 + | | | | cracks/crazing |
| | 0.80% CYASORB ™ UV-2908 | | | | |
| 9-4 | 99.12% Polypropylene + | 13.72 | 8.48 | 4.87 | No |
| | 0.08% CYANOX ™ 2777 + | | | | cracks/crazing |
| | 0.80% TINUVIN ™ 120 | | | | |

Samples 9-3 and 9-4 demonstrate that polypropylene containing both antioxidant and hindered benzoate shows less discoloration upon UV-C irradiation than polypropylene containing antioxidants only (Sample 9-2), as evidenced by Delta E and Delta Y1 results of Table 9. Sample 9-4 demonstrates that polypropylene containing both antioxidant and hindered benzoate shows less surface photodegradation upon UV-C irradiation than both unstabilized polypropylene (Sample 9-1) and polypropylene containing antioxidants only (Sample 9-2), as evidenced by the surface cracks/crazing observations of Table 9.

### Example 9

### UV-C Weathering Performance (Delta E, Delta Y1, and Cracking/Crazing) of Polypropylene Containing a Combination of Antioxidants, UV Absorbers, and Hindered Amine Light Stabilizers

TABLE 10
UV-C Weathering Performance of Polypropylene Stabilized by Combinations of
Antioxidants, UV Absorbers and Hindered Amine Light Stabilizers

| | | YI | Delta YI | Delta E | Cracks/Crazing |
|---|---|---|---|---|---|
| Sample | Formulation | (0 h) | (250 h) | (250 h) | (250 h) |
| 10-1 | 100% Polypropylene | 10.37 | 4.17 | 2.46 | Significant |
| | | | | | cracks/crazing |
| 10-2 | 99.92% Polypropylene + | 12.51 | 15.15 | 7.39 | Some |
| | 0.08% CYANOX ™ 2777 | | | | cracks/crazing |
| 10-3 | 99.12% Polypropylene + | 15.8 | 0.05 | 0.31 | No |
| | 0.08% CYANOX ™ 2777 + | | | | cracks/crazing |
| | 0.50% TINUVIN ™ 1577 + | | | | |
| | 0.30% CHIMASSORB ™ 2020 | | | | |
| 10-4 | 99.12% Polypropylene + | 15.22 | −0.5 | 0.63 | No |
| | 0.08% CYANOX ™ 2777 + | | | | cracks/crazing |
| | 0.50% TINUVIN ™ 1577+ | | | | |
| | 0.30% TINUVIN ™ 622 | | | | |
| 10-5 | 98.82% Polypropylene + | 16.16 | −0.95 | 0.53 | No |
| | 0.08% CYANOX ™ 2777 + | | | | cracks/crazing |
| | 0.5% TINUVIN ™ 1577+ | | | | |
| | 0.6% CYASORB ™ UV-3853PP5 | | | | |
| 10-6 | 99.12% Polypropylene + | 15.1 | 0.87 | 0.92 | Small |
| | 0.08% CYANOX ™ 2777 + | | | | cracks/crazing |
| | 0.50% CYASORB ™ UV-1164 + | | | | |
| | 0.30% CHIMASSORB ™ 2020 | | | | |
| 10-7 | 99.12% Polypropylene + | 14.23 | 0.56 | 0.59 | No |
| | 0.08% CYANOX ™ 2777 + | | | | cracks/crazing |
| | 0.50% CYASORB ™ UV-1164 + | | | | |
| | 0.30% TINUVIN ™ 622 | | | | |
| 10-8 | 98.82% Polypropylene + | 14.52 | −0.09 | 0.42 | No |
| | 0.08% CYANOX ™ 2777 + | | | | cracks/crazing |
| | 0.50% CYASORB ™ UV-1164 + | | | | |
| | 0.60% CYASORB ™ UV-3853PP5 | | | | |

Samples 10-3 to 10-8 demonstrate that polypropylene containing antioxidants in combination with UV absorbers and hindered amine light stabilizers show less discoloration and less surface photodegradation upon UV-C irradiation than both unstabilized polypropylene (Sample 10-1) and polypropylene containing antioxidants only (Sample 10-2), as evidenced by the delta E and delta YI results and the observations on surface cracks/crazing development in Table 10.

### Example 10

### UV-C Weathering Performance (Delta E, Delta Y1, and Cracking/Crazing) of Polypropylene Containing a Combination of Antioxidants, UV Absorbers, Hindered Benzoates, and Hindered Amine Light Stabilizers

TABLE 11
UV-C Weathering Performance of Polypropylene Stabilized by Combinations of
Antioxidants, UV Absorbers, Hindered Benzoates, and Hindered Amine Light Stabilizers

| | | YI | Delta YI | Delta E | Cracks/Crazing |
|---|---|---|---|---|---|
| Sample | Formulation | (0 h) | (42 h) | (42 h) | (250 h) |
| 11-1 | 100% Polypropylene | 10.37 | 4.17 | 2.46 | Significant |
| | | | | | cracks/crazing |
| 11-2 | 99.92% Polypropylene + | 12.51 | 15.15 | 7.39 | Some |
| | 0.08% CYANOX ™ 2777 | | | | cracks/crazing |
| 11-3 | 99.12% Polypropylene + | 14.8 | 0.83 | 1.06 | No |
| | 0.08% CYANOX ™ 2777 + | | | | cracks/crazing |
| | 0.50% CYASORB ™ UV-1164 + | | | | |
| | 0.15% CYASORB ™ UV-2908 + | | | | |
| | 0.15% CHIMASSORB ™ 2020 | | | | |
| 11-4 | 99.12% Polypropylene + | 14.97 | 1.37 | 1.30 | No |
| | 0.08% CYANOX ™ 2777 + | | | | cracks/crazing |
| | 0.50% CYASORB ™ UV-1164 + | | | | |
| | 0.15% TINUVIN ™ 120 + | | | | |
| | 0.15% CHIMASSORB ™ 2020 | | | | |
| 11-5 | 99.12% Polypropylene + | 16.78 | −0.55 | 0.46 | No |
| | 0.08% CYANOX ™ 2777 + | | | | cracks/crazing |
| | 0.50% TINUVIN ™ 1577 + | | | | |
| | 0.15% CYASORB ™ UV-2908 + | | | | |
| | 0.15% CHIMASSORB ™ 2020 | | | | |
| 11-6 | 99.12% Polypropylene + | 16.41 | −0.23 | 0.51 | No |
| | 0.08% CYANOX ™ 2777 + | | | | cracks/crazing |
| | 0.50% TINUVIN ™ 1577+ | | | | |
| | 0.15% TINUVIN ™ 120 + | | | | |
| | 0.15% CHIMASSORB ™ 2020 | | | | |
| 11-7 | 98.97% Polypropylene + | 14.25 | 1.26 | 1.04 | No |
| | 0.08% CYANOX ™ 2777 + | | | | cracks/crazing |
| | 0.50% CYASORB ™ UV-1164 + | | | | |
| | 0.15% CYASORB ™ UV-2908 + | | | | |
| | 0.30% CYASORB ™ UV-3853PP5 | | | | |
| 11-8 | 98.97% Polypropylene + | 15.35 | 1.2 | 1.14 | No |
| | 0.08% CYANOX ™ 2777 + | | | | cracks/crazing |
| | 0.50% CYASORB ™ UV-1164 + | | | | |
| | 0.15% TINUVIN ™ 120 + | | | | |
| | 0.30% CYASORB ™ UV-3853PP5 | | | | |
| 11-9 | 98.97% Polypropylene + | 16.59 | −0.02 | 0.61 | No |
| | 0.08% CYANOX ™ 2777 + | | | | cracks/crazing |
| | 0.50% TINUVIN ™ 1577+ | | | | |
| | 0.15% CYASORB ™ UV-2908 + | | | | |
| | 0.30% CYASORB ™ UV-3853PP5 | | | | |
| 11-10 | 98.97% Polypropylene + | 17.15 | 0.09 | 0.56 | No |
| | 0.08% CYANOX ™ 2777 + | | | | cracks/crazing |
| | 0.50% TINUVIN ™ 1577 + | | | | |
| | 0.15% TINUVIN ™ 120 + | | | | |
| | 0.30% CYASORB ™ UV-3853PP5 | | | | |

Samples 11-3 to 11-10 demonstrate that polypropylene containing antioxidants in combination with UV absorbers, hindered benzoates, and hindered amine light stabilizers show less discoloration and less photodegradation upon UV-C irradiation than unstabilized polypropylene (Sample 11-1) and polypropylene containing antioxidants only (Sample 11-2), as evidenced by the delta E and delta YI results and the observations on surface cracks/crazing in Table 11.

### Example 11

### UV-C Weathering Performance (Delta E and Delta YI) of Polypropylene Containing a Antioxidants and Other Additives

Results are presented in Table 12, below.

TABLE 12

| | | YI | Delta | Delta |
|---|---|---|---|---|
| | | (0 | YI (24 | E (24 |
| Sample | Formulation | hours) | hours) | hours) |
| 12-1 | 100% Polypropylene | 10.02 | −0.04 | 0.25 |
| 12-2 | 99.85% Polypropylene + | 9.26 | 1.09 | 0.68 |
| | 0.15% WESTON ™ 618 | | | |
| 12-3 | 99.05% Polypropylene + | 12.09 | 0.62 | 0.41 |
| | 0.40% CYASORB ™ UV-1164 + | | | |
| | 0.40% CYASORB ™ UV-3346 + | | | |
| | 0.15% WESTON ™ 618 | | | |
| 12-4 | 99.05% Polypropylene + | 12.81 | −0.45 | 0.25 |
| | 0.40% CYASORB ™ UV-1164 + | | | |
| | 0.40% TINUVIN ™ 770 + | | | |
| | 0.15% WESTON ™ 618 | | | |
| 12-5 | 98.95% Polypropylene + | 11.92 | 2.58 | 1.37 |
| | 0.40% CYASORB ™ UV-1164 + | | | |
| | 0.40% CYASORB ™ UV-3346 + | | | |
| | 0.10% IRGANOX ™ 1010 + | | | |
| | 0.15% WESTON ™ 618 | | | |
| 12-6 | 98.95% Polypropylene + | 12.84 | 4.50 | 2.33 |
| | 0.40% CYASORB ™ UV-1164 + | | | |
| | 0.40% TINUVIN ™ 770 + | | | |
| | 0.10% IRGANOX ™ 1010 + | | | |
| | 0.15% WESTON ™ 618 | | | |

Table 12 demonstrates that WESTONTM 618 shows minimal discoloration in polypropylene after UV-C exposure (Compare Sample 12-2 (WESTON™ 618) with Sample 2-2 (IRGAFOS™ 168). Adding various UV stabilizers increases initial YI but maintains/decreases change in color (delta E) over UV-C exposure, as demonstrated by

Samples 12-3 and 12-4. Adding IRGANOX™ 1010 to the formulations makes the plaques more susceptible to discoloration from UV-C exposure (See Samples 12-5 and 12-6).

### Example 12

### UV-C Weathering Performance (Delta E and Delta YI) of Polypropylene Containing a Hindered Phenol and Other Additives

This study is generally based on Example 2, supra, but the UV loading (% by weight) is higher. Results are shown in Table 13, below.

TABLE 13

| | | YI | Delta | Delta |
|---|---|---|---|---|
| | | (0 | YI (24 | E (24 |
| Sample | Formulation | hours) | hours) | hours) |
| 13-1 | 100% Polypropylene | 9.72 | 0.35 | 0.27 |
| 13-2 | 99.90% Polypropylene + | 9.28 | 6.91 | 3.76 |
| | 0.10% IRGANOX ™ 1010 | | | |
| 13-3 | 99.30% Polypropylene + | 19.73 | 1.95 | 0.93 |
| | 0.60% CYASORB ™ UV-1164 + | | | |
| | 0.10% IRGANOX ™ 1010 | | | |
| 13-4 | 99.30% Polypropylene + | 17.67 | 5.98 | 2.82 |
| | 0.60% CYASORB ™ UV-5411 + | | | |
| | 0.10% IRGANOX ™ 1010 | | | |
| 13-5 | 99.30% Polypropylene + | 20.37 | 0.87 | 0.46 |
| | 0.60% CYASORB ™ UV-531 + | | | |
| | 0.10% IRGANOX ™ 1010 | | | |
| 13-6 | 99.30% Polypropylene + | 12.38 | 4.22 | 2.15 |
| | 0.60% CYASORB ™ UV-3346 + | | | |
| | 0.10% IRGANOX ™ 1010 | | | |
| 13-7 | 99.30% Polypropylene + | 15.41 | 19.44 | 9.55 |
| | 0.60% TINUVIN ™ 770 + | | | |
| | 0.10% IRGANOX ™ 1010 | | | |

Similar to the data in Table 3, the data in Table 13 demonstrates that polypropylene formulated with a common hindered phenol experiences discoloration upon UV-C exposure. (Compare Samples 13-2 and 3-2 with Samples 13-1 and 3-1.) However, certain light stabilizers in combination with the hindered phenol mitigate discoloration upon UV-C exposure, as demonstrated by the lower delta YI and delta E values presented in Table 13 (See Samples 13-3 to 13-6). The higher UV loadings do seem to have a slight benefit with regard to delta YI (Compare Samples 13-2 to 13-6 with 3-2 to 3-6).

### Example 13

### UV-C Weathering Performance (Delta E and Delta YI) of Polyethylene Containing a Phosphite and Other Additives

The performances of various individual additive materials as well as their specific combinations are evaluated in regard to protecting polymers from UV-C induced discoloration and photodegradation. High density polyethylene (SCLAIR® 2909) from NOVA Chemicals is chosen as the polymer matrix for the weathering studies in these examples. Information regarding the suppliers, commercial names, and chemical names of various additive materials in formulating the examples is listed in Table 1, supra. All additive materials are used as received.

The general procedure for the preparation of plaques containing the additives is as follows. 1,000 grams powder mixtures of each formulation are prepared by dry blending the additives with the polyethylene resin. The mixtures are then compounded at 190° C. with a Werner & Pfleiderer twin screw extruder. After extrusion, standard rectangular plaques (2×2.5×0.125 inch) are injection molded at 190° C. into rectangular plaques with an Engel injection molding machine.

The UV-C weathering studies are performed as detailed in the prior examples, using the UV-C weathering apparatus as described. Changes in color (delta E) and in Yellowness Index (delta YI) of the plaque surface after UV-C exposure are also determined in the same manner. Results of the UV-C weathering performance of polyethylene with phosphites and other additives are presented below in Table 12.

TABLE 14
UV-C Weathering Performance of Polypropylene Containing
Phosphite and Other Additives.

| | | YI | Delta | Delta |
|---|---|---|---|---|
| | | (0 | YI (24 | E (24 |
| Sample | Formulation | hours) | hours) | hours) |
| 14-1 | 100% Polyethylene | 1.93 | 7.97 | 4.63 |
| 14-2 | 99.85% Polyethylene + | −1.55 | 17.78 | 10.40 |
| | 0.15% IRGAFOS ™ 168 | | | |
| 14-3 | 99.45% Polypropylene + | 3.23 | 5.31 | 3.00 |
| | 0.40% CYASORB ™ UV-1164 + | | | |
| | 0.15% IRGAFOS ™ 168 | | | |
| 14-4 | 99.45% Polyethylene + | −0.50 | 7.18 | 4.06 |
| | 0.40% CYASORB ™M UV-5411 + | | | |
| | 0.15% IRGAFOS ™ 168 | | | |
| 14-5 | 99.45% Polyethylene + | 2.57 | 2.37 | 1.43 |
| | 0.40% CYASORB ™ UV-531 + | | | |
| | 0.15% IRGAFOS ™ 168 | | | |
| 14-6 | 99.45% Polyethylene + | −1.13 | 10.92 | 6.40 |
| | 0.40% CYASORB ™ UV-3346 + | | | |
| | 0.15% IRGAFOS ™ 168 | | | |
| 14-7 | 99.45% Polyethylene + | 1.34 | 31.47 | 16.74 |
| | 0.40% TINUVIN ™ 770 + | | | |
| | 0.15% IRGAFOS ™ 168 | | | |

The data in Table 14 demonstrates that polyethylene formulated with a common phosphite antioxidant experiences significant discoloration upon UV-C exposure compared to neat, unstabilized polyethylene. (Compare Sample 14-2 with Sample 14-1, for example). However, certain light stabilizers in combination with the phosphite mitigate discoloration upon UV-C exposure, as demonstrated by lower delta YI and delta E values presented in Table 14 (See Samples 14-2 to 14-6).

### Example 14 —UV-C Weathering Performance (delta E and delta YI) of Polyethylene Containing a Hindered Phenol and Other Additives

Results are presented in Table 15, below.

TABLE 15

| | | YI | Delta | Delta |
|---|---|---|---|---|
| | | (0 | YI (24 | E (24 |
| Sample | Formulation | hours) | hours) | hours) |
| 15-1 | 100% Polyethylene | 1.93 | 7.97 | 4.63 |
| 15-2 | 99.90% Polyethylene + | 0.15 | 11.51 | 6.77 |
| | 0.10% IRGANOX ™ 1010 | | | |
| 15-3 | 99.50% Polyethylene + | 3.41 | 2.25 | 1.31 |
| | 0.40% CYASORB ™ UV-1164 + | | | |
| | 0.10% IRGANOX ™ 1010 | | | |
| 15-4 | 99.50% Polyethylene + | 0.10 | 9.53 | 5.28 |
| | 0.40% CYASORB ™ UV-5411 + | | | |
| | 0.10% IRGANOX ™ 1010 | | | |
| 15-5 | 99.50% Polyethylene + | 2.75 | 1.06 | 0.64 |
| | 0.40% CYASORB ™ UV-531 + | | | |
| | 0.10% IRGANOX ™ 1010 | | | |
| 15-6 | 99.50% Polyethylene + | −0.96 | 12.99 | 7.64 |
| | 0.40% CYASORB ™ UV-3346 + | | | |
| | 0.10% IRGANOX ™ 1010 | | | |
| 15-7 | 99.50% Polyethylene + | −0.16 | 31.29 | 16.98 |
| | 0.40% TINUVIN ™ 770 + | | | |
| | 0.10% IRGANOX ™ 1010 | | | |

The data in Table 15 demonstrate that polyethylene formulated with a common hindered phenol experiences significant discoloration upon UV-C exposure. (Compare Sample 15-2 with Sample 15-1). However, certain light stabilizers in combination with the hindered phenol mitigate discoloration upon UV-C exposure, as demonstrated by the lower delta YI and delta E values presented in Table 15 (Samples 15-3 to 15-5).

### Example 15

### 222 nm UV-C Weathering Performance (Delta E and Delta YI) of Polyethylene Containing a Phosphite and Other Additives

The study conducted for Example 13 is repeated, but instead of performing the UV-C weathering at 254 nm, the weathering apparatus is modified to contain three KrCl Excimer UV-C lamps (222 nm) with an average irradiance of ca. 190 μW/cm² (at 222 nm) at the plaque surface as well as an automatic fan controller in order to maintain the test temperature below 40° C. During the UV-C weathering tests, plaques were placed inside the apparatus and repositioned frequently to ensure all samples received an equal amount of radiant exposure.

Changes in color (delta E) and in Yellowness Index (delta YI) of the plaque surface after UV-C exposure are determined in the same manner as the prior Examples. Results of the UV-C weathering performance of polyethylene with phosphites and other additives are presented below in Table 16.

TABLE 16
222 nm UV-C Weathering Performance of Polyethylene
Containing Phosphites and Other Additives.

| | | | Delta YI | Delta E |
|---|---|---|---|---|
| Sample | Formulation | YI (0 hours) | (120 hours) | (120 hours) |
| 16-1 | 100% Polyethylene | 0.63 | 6.13 | 3.71 |
| 16-2 | 99.85% Polyethylene + | −1.56 | 11.62 | 6.84 |
| | 0.15% IRGAFOS ™ 168 | | | |
| 16-3 | 99.45% Polyethylene + | 3.34 | 5.29 | 3.06 |
| | 0.40% CYASORB ™ UV-1164 + | | | |
| | 0.15% IRGAFOS ™ 168 | | | |
| 16-4 | 99.45% Polyethylene + | −0.45 | 6.19 | 3.60 |
| | 0.40% CYASORB ™ UV-5411 + | | | |
| | 0.15% IRGAFOS ™ 168 | | | |
| 16-5 | 99.45% Polyethylene + | 2.54 | 3.33 | 1.98 |
| | 0.40% CYASORB ™ UV-531 + | | | |
| | 0.15% IRGAFOS ™ 168 | | | |
| 16-6 | 99.45% Polyethylene + | −1.38 | 4.49 | 2.69 |
| | 0.40% CYASORB ™ UV-3346 + | | | |
| | 0.15% IRGAFOS ™ 168 | | | |
| 16-7 | 99.45% Polyethylene + | 2.83 | 32.44 | 17.10 |
| | 0.40% TINUVIN ™ 770 + | | | |
| | 0.15% IRGAFOS ™ 168 | | | |

The data in Table 16 demonstrates that polyethylene formulated with a common phosphite experiences discoloration upon UV-C exposure. (Compare Sample 16-2 with Sample 16-1.) However, certain light stabilizers in combination with the phosphite mitigate discoloration upon UV-C exposure, as demonstrated by the lower delta YI and delta E values presented in Table 16 (Samples 16-3 to 16-6).

These results presented in the foregoing examples generally demonstrate that the stabilizer compositions for making polymeric articles disclosed herein are effective in providing resistance to the deleterious effects of discoloration, cracking, and/or crazing when the polymeric articles are subjected to repeated or prolonged exposure to a UV-C (190-280nm) disinfectant (germicidal) light source. The data pertaining to the use of HALS bis(2,2,6,6,-tetramethyl-4-piperidyl) sebacate (TINUVIN™ 770) does not fully support its use as an additive to resist a deleterious effect of a polymer composition upon exposure to UV-C irradiation, and Applicant has disclaimed it from the invention accordingly. The data is provided, nonetheless, to demonstrate that it cannot merely be inferred that the stabilizer additives beneficial or useful in preventing the deleterious effects of polymer compositions upon exposure to UV-A and/or UV-B will also be beneficial or useful for preventing such deleterious effects to polymer compositions from UV-C exposure.In further support of the concept that use of stabilizer additives for UV- A/UV-B cannot be inferred as useful for UV-C, impact studies of various UV stabilizers and antioxidants on polycarbonate upon UV-C exposure are presented below.

### Example 16

### Impact of Standard UV Stabilizers/Antioxidants on Polycarbonate Materials After 254 nm UV-C Exposure

Polycarbonate is known to be a high-performance engineering thermoplastic used in a variety of applications including but not limited to compact discs, safety helmets, bullet-proof glass, safety glasses, and car headlamp lenses. Although any polymer linked together by carbonate groups (—O—(C═O)—O—) could be considered a polycarbonate, the most ubiquitous one used is based on bisphenol A (BPA). Polycarbonate has many advantageous properties including high impact strength, high toughness, optical clarity, chemical resistance, heat resistance, high dimensional stability, good electrical properties, and low weight. Polycarbonates are known to be protected from the deleterious effects of UV-A and/or UV-B irradiation with a variety of stabilizer compositions that are well known to those skilled in the art. Accordingly, it would be desirous if polycarbonate materials were resistant to discoloration due to UV irradiation at wavelengths below 300 nm.

The intention of this experiment is to see if similar trends are observed from the polypropylene studies exemplified above

The study in this example was performed using LUPOY™ 1201 10P natural polycarbonate (LG Chemical) (PC) as the base resin. The amounts of additives used in PC are described in terms of weight percentages (wt. %) and are described this way throughout. Extrusion is performed on the Killion single screw at 550° F. (−290° C.) melt temperature. The temperature zones were 480° F., 525° F., 550° F., and 550° F. at the nozzle. Injection molding is performed on an Engel machine at 295° C. The temperature zones were 275° C., 285° C., 295° C., and 295° C. at the nozzle. All samples are dried in a vacuum oven for a minimum of 4 hours and cooled in a sealed glass jar for 1 hour before mixing with additives and adding into an extruder. Samples are prepared and exposed as 2×2×0.125 inch plaques.

UVC exposure at 254 nm is performed with an in-house chamber equipped with two low pressure mercury light sources and a calibrated radiometer to measure irradiance over time. The average irradiance for exposed samples is ˜1.5 mW/cm². The average temperature is about 30° C. Color was measured on a Ci7800 Spectrophotometer calibrated to the Hunter LAB scale using a D65 illuminant at 10° viewer angle. Color is measured on a Ci7800 Spectrophotometer calibrated to the Hunter LAB scale using a D65 illuminant at 10° viewer angle.

Table 17 lists the various formulations considered in the study.

TABLE 17
Evaluation of Standard UV absorbers, Hindered Amine Light
Stabilizers, Hindered Benzoates, and Antioxidants on
Polycarbonate After 254 nm UV-C Exposure.

| | UV Absorber/HALS/HB | Antioxidant |
|---|---|---|
| Formulation | (loading %) | (loading %) |
| 17-1 | — | — |
| 17-2 | — | AO-618 (0.25%) |
| 17-3 | UV-5411 (0.40%) | AO-618 (0.25%) |
| 17-4 | Tin-234 (0.40%) | AO-618 (0.25%) |
| 17-5 | Tin-360 (0.40%) | AO-618 (0.25%) |
| 17-6 | UV-1164 (0.40%) | AO-618 (0.25%) |
| 17-7 | UV-1577 (0.40%) | AO-618 (0.25%) |
| 17-8 | UV-531 (0.40%) | AO-618 (0.25%) |
| 17-9 | UV-2908 (0.40%) | AO-618 (0.25%) |
| 17-10 | Tin-120 (0.40%) | AO-618 (0.25%) |
| 17-11 | UV-3638F (0.40%) | AO-618 (0.25%) |
| 17-12 | UV-3346 (0.40%) | AO-618 (0.25%) |
| 17-13 | UV-3529 (0.40%) | AO-618 (0.25%) |
| 17-14 | Uvinul 3030 (0.40%) | AO-618 (0.25%) |
| 17-15 | UV-531 (0.20%) + UV-2908 (0.20%) | AO-618 (0.25%) |
| 17-16 | UV-1577 (0.20%) + UV-2908 (0.20%) | AO-618 (0.25%) |
| 17-17 | UV-5411 (0.20%) + UV-2908 (0.20%) | AO-618 (0.25%) |
| 17-18 | UV-3529 (0.20%) + UV-2908 (0.20%) | AO-618 (0.25%) |
| 17-19 | — | AO-168 (0.25%) |
| 17-20 | UV-5411 (0.40%) | AO-168 (0.25%) |
| 17-21 | Tin-234 (0.40%) | AO-168 (0.25%) |
| 17-22 | Tin-360 (0.40%) | AO-168 (0.25%) |
| 17-23 | UV-1164 (0.40%) | AO-168 (0.25%) |
| 17-24 | UV-1577 (0.40%) | AO-168 (0.25%) |
| 17-25 | UV-531 (0.40%) | AO-168 (0.25%) |
| 17-26 | UV-2908 (0.40%) | AO-168 (0.25%) |
| 17-27 | Tin-120 (0.40%) | AO-168 (0.25%) |
| 17-28 | UV-3638F (0.40%) | AO-168 (0.25%) |

Although a diverse array of samples was put together for testing, the results indicated that all stabilizers evaluated had a relatively small impact on mitigating discoloration in polycarbonate after 254 nm UV-C exposure. Interestingly, formulations including UV-1164 appeared to contribute additional color to the PC samples, particularly in Formulation 17-6 when combined with AO-618. When UV-1164 was combined with AO-168 (Formulation 17-23), the initial discoloration was lower. This discoloration was also noted in UV-1577 but generally to a lesser degree. Higher initial yellowness was also observed with UV-3346 combined with AO-618. Polycarbonate is sensitive to basic species so it could be possible that UV-3346 caused initial degradation to PC before UV- C exposure.

Regarding total color change, Formulation 17-6 (UV-1164 +AO-618) technically showed the lowest change. However, the initial color was highest in this formulation so it is possible the discoloration from the UV-C exposure was masked by the high initial color. The rest of the formulations tested showed a color change near 4 units (±0.5 units) after 12 hours, and only a minimal increase in color from 12 hours to 30 hours.

We claim:

1. A polymer composition for making a stabilized polymeric article that is resistant to at least one deleterious effect of discoloration, cracking, or crazing upon exposure to UV-C (190-280 nm) light, the polymer composition comprising:
i) an organic polymeric material; and
ii) a stabilizer composition comprising:
an antioxidant selected from the group consisting of hindered phenols, phosphites and phosphonites, and mixtures thereof; and
a light stabilizer selected from the group consisting of hindered amine light stabilizers (HALS), UV absorbers (UVA), hindered benzoates, and mixtures thereof
even where barium compounds (such as barium salts) are absent from the stabilizer composition, and with the proviso that the HALS is not bis(2,2,6,6,-tetramethyl-4-piperidyl) sebacate (TINUVIN™ 770) alone.

2. The polymer composition of claim 1, wherein at least one of reduced discoloration, cracking, or crazing upon exposure to UV-C light is associated with the use of the light stabilizer in combination with the antioxidant compared to the antioxidant in the absence of the light stabilizer.

3. The polymer composition of claim 1, wherein the organic polymeric material comprises at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

4. The polymer composition of claim 1, wherein the organic polymeric material comprises at least one of (i) polyethylene, polypropylene, polyisobutylene, polybut-1-ene, or poly-4-methylpent-1-ene; (ii) polyisoprene or polybutadiene; (iii) cyclopentene or norbornene; (iv) optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); (v) a thermoplastic olefin (TPO); or (vi) copolymers of at least one of mono-, di-, or cyclo-olefins.

5. The polymer composition of claim 4, wherein the organic polymeric material is polypropylene, polyethylene, or thermoplastic olefins.

6. The polymer composition of claim 1, wherein the antioxidant is present at from 0.001 to 5.0%, preferably from 0.005 to 3.0%, and more preferably from 0.01 to 1.0% by weight, based on the total weight of the polymer composition.

7. The polymer composition of claim 1, wherein the light stabilizer is present at from 0.005 to 5.0% by weight, preferably from 0.01 to 2.0% by weight, based on the total weight of the polymer composition.

8. The polymer composition of claim 1, wherein the antioxidant comprises a hindered phenol having at least one group according to Formulae (IVa), (IVb), or (IVc): 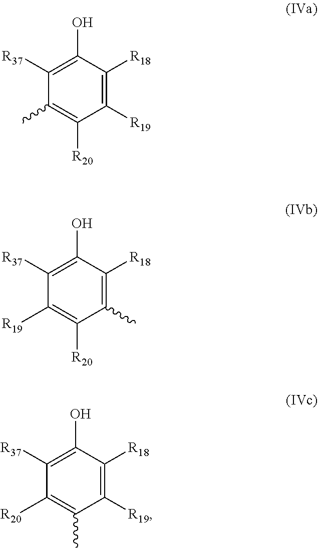
wherein:
“ [symbol] ” indicates the point of attachment (via a carbon-carbon single bond) of the molecular fragment to a parent compound;
R₁₈ of Formulae (IVa), (IVb), or (IVc) is hydrogen or C₁₋₁₂ hydrocarbyl;
R₁₉ and R₂₀ of Formulae (IVa), (IVb), or (IVc) are each independently hydrogen or C₁-C₂₀ hydrocarbyl; and
R₃₇ of Formulae (IVa), (IVb), or (IVc) is C₁-C₁₂ hydrocarbyl.

9. The polymer composition of claim 8, wherein R₁₈ and R₃₇ of Formulae (IVa), (IVb), or (IVc) are each independently methyl or tent-butyl.

10. The polymer composition of claim 8, wherein the hindered phenol comprises at least one of:
1,3,5-tris(4-tert-butyl-3-hydroxy-2,6-dimethylbenzyl)-1,3,5-triazine-2,4,6-(1H,3H,5H)-trione (CYANOX™ 1790),
1,3,5-tris(3,5-di-tert-butyl-4-hydroxybenzyl)-1,3,5-triazine-2,4,6-(1H,3H,5H)-trione (IRGANOX™ 3114),
1,1,3-tris(2′-methyl-4′-hydroxy-5′-tert-butylphenyl)butane,
triethylene glycol bis[3-(3-tert-butyl-4-hydroxy-5-methylphenyl)propionate],
4,4′-thiobis(2-tert-butyl-5-methylphenol),
2,2′-thiodiethylene bis[3-(3-tert-butyl-4-hydroxyl-5-methylphenyl)propionate],
octadecyl 3-(3-tert-butyl-4-hydroxy-5-methylphenyl)propionate, p1 pentaerythritol (3-tert-butyl-4-hydroxy-5-methylphenyl)propionate,
N,N′-hexamethylene bis[3-(3-tert-butyl-4-hydroxy-5-methylphenyl)propionamide],
di(4-tert-butyl-3-hydroxy-2,6-dimethylbenzyl)thiodipropionate,
pentaerythritol tetrakis(3-(3,5-di-tert-butyl-4-hydroxyphenyl)propionate) (IRGANOX™ 1010),
octadecyl 3-(3,5-di-tert-butyl-4-hydroxyphenyl)propionate (IRGANOX™ 1076), or
N,N′-bis(3,5-di-tert-butyl-4-hydroxylphenyl propionyl)hydrazine (IRGANOX™ 1024).

11. The polymer composition of claim 8, wherein the hindered phenol comprises at least one of pentaerythritol tetraki s(3-(3,5-di-tert-butyl-4-hydroxyphenyl)propionate) (IRGANOX™ 1010), octadecyl 3-(3,5-di-tert-butyl-4-hydroxyphenyl)propionate (IRGANOX™ 1076), 1,3,5-tris(3,5-di-tert-butyl-4-hydroxybenzyl)-1,3,5-triazine-2,4,6-(1H,3H, 5H)-trione (IRGANOX™ 3114), or N,N′-bis(3,5-di-tert-butyl-4-hydroxylphenyl propionyl)hydrazine (IRGANOX™ 1024).

12. The polymer composition of claim 1, wherein the antioxidant comprises the phosphite or phosphonite, and the phosphite or phosphonite is at least one of:
i) a compound according to any of Formulae (1) to (7): 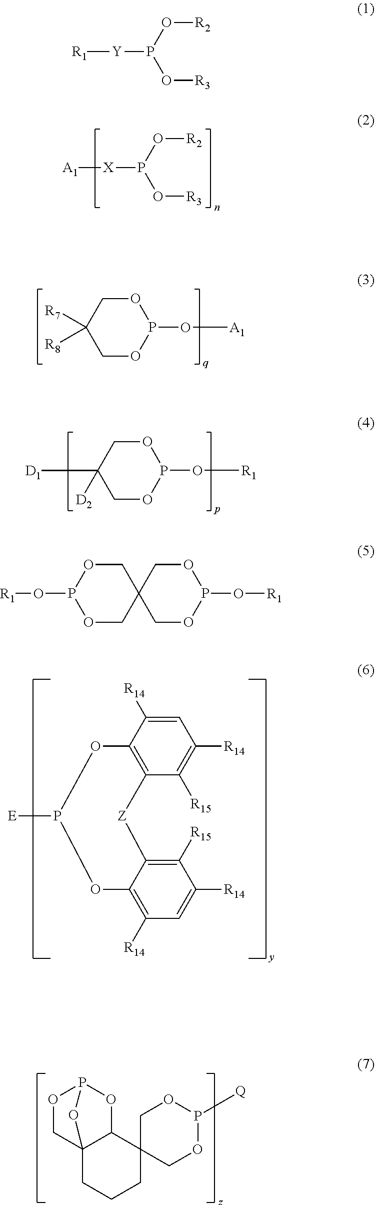
wherein:
the indices are integral and n is 2, 3 or 4; p is 1 or 2; q is 2 or 3; y is 1, 2 or 3; and z is 1 to 6;
A₁, if n or q is 2, is C₂-C₁₈ alkylene; C₂-C₁₂ alkylene interrupted by oxygen, sulfur or —NR₄—, a radical of the formulae: 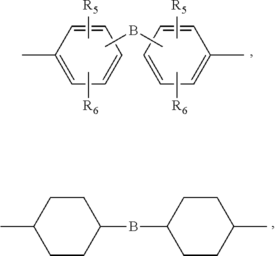
or phenylene;
A₁, if n or q is 3, is a divalent radical of the formula —CᵣH₂ᵣ₋₁—, wherein r is an integer from 4 to 12;
A₁, if n is 4, is 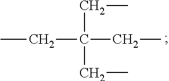
B is a direct bond, —CH₂—, —CHR₄—, —CR₁R₄—, sulfur, C₅-C₇ cycloalkylidene, or cyclohexylidene which is substituted by from 1 to 4 C₁-C₄ alkyl radicals in position 3, 4 and/or 5;
D₁, if p is 1, is C₁-C₄ alkyl and, if p is 2, is —CH₂OCH₂—;
D₂ is C₁-C₄ alkyl;
E, if y is 1, is C₁-C₁₈ alkyl, —OR₁ or halogen;
E, if y is 2, is —O-A₂-O—, wherein A₂ is as defined for A₁ when n is 2;
E, if y is 3, is a radical of the formula R₄C(CH₂O)₃ or N(CH₂CH₂O—)₃;
Q is the radical of an at least z-valent mono- or poly-alcohol or phenol, this radical being attached via the oxygen atom of the OH group of the mono- or poly-alcohol or phenol to the phosphorus atom;
R₁, R₂ and R₃ are each independently C₁-C₁₈ alkyl which is unsubstituted or substituted by halogen, —COOR₄, —CN or —CONR₄R₄; C₂-C₁₈ alkyl interrupted by oxygen, sulfur or —NR₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula 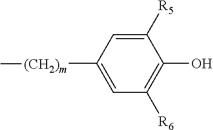
in which m is an integer from the range 3 to 6;
R₄ is hydrogen, C₁-C₈ alkyl, C₅-C₁₂ cycloalkyl or C₇-C₉ phenylalkyl;
R₅ and R₆ are each independently hydrogen, C₁-C₈ alkyl or C₅-C₆ cycloalkyl,
R₇ and R₈, if q is 2, are each independently C₁-C₄ alkyl or together are a 2,3-dehydropentamethylene radical; and R₇ and R₈, if q is 3, are each methyl;
each instance of R₁₄ is independently chosen from hydrogen, C₁-C₉ alkyl or cyclohexyl;
each instance of R₁₅ is independently hydrogen or methyl;
X and Y are each a direct bond or oxygen;
Z is a direct bond, methylene, —C(R₁₆)₂—or sulfur, and
R₁₆ is C₁-C₈ alkyl; or
ii) a trisarylphosphite according to Formula 8: 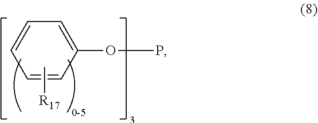
wherein:
R₁₇ is a substituent present at from 0 to 5 instances of the aromatic ring of Formula 8 and in each instance is independently chosen from C₁-C₂₀ alkyl, C₃-C₂₀ cycloalkyl, C₄-C₂₀ alkyl cycloalkyl, C₆-C₁₀ aryl, or C₇-C₂₀ alkylaryl.

13. The polymer composition of claim 12, wherein the phosphite or phosphonite comprises at least one of:
triphenyl phosphite,
diphenyl alkyl phosphites,
phenyl dialkyl phosphites,
trilauryl phosphite,
trioctadecyl phosphite,
distearyl pentaerythritol phosphite,
tris(2,4-di-tert-butylphenyl) phosphite (IRGAFOS™ 168),
tris(4-nonylphenyl) phosphite,
a compound of Formulae (A), (B), (C), (D), (E), (F), (G), (H), (J), (K), or (L): 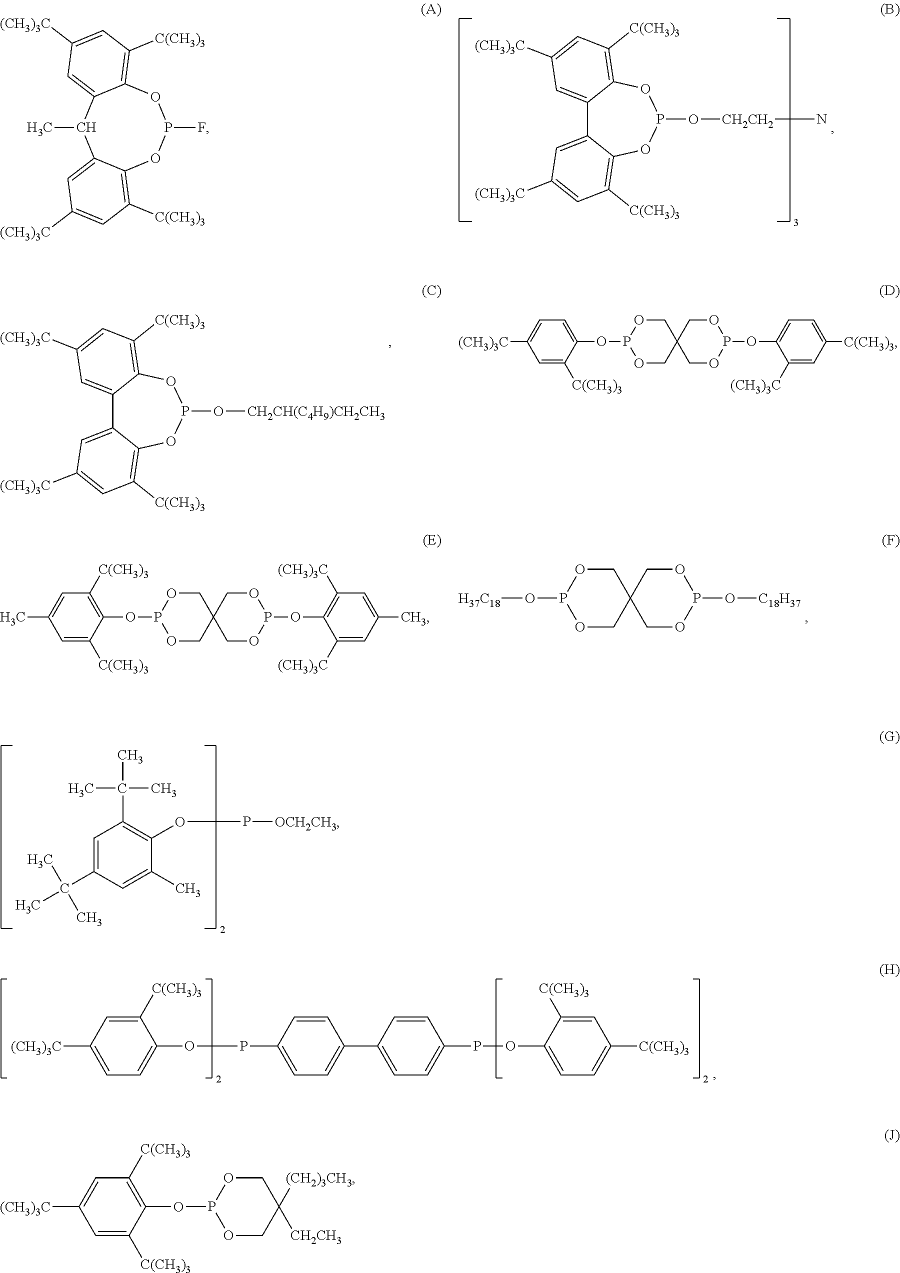 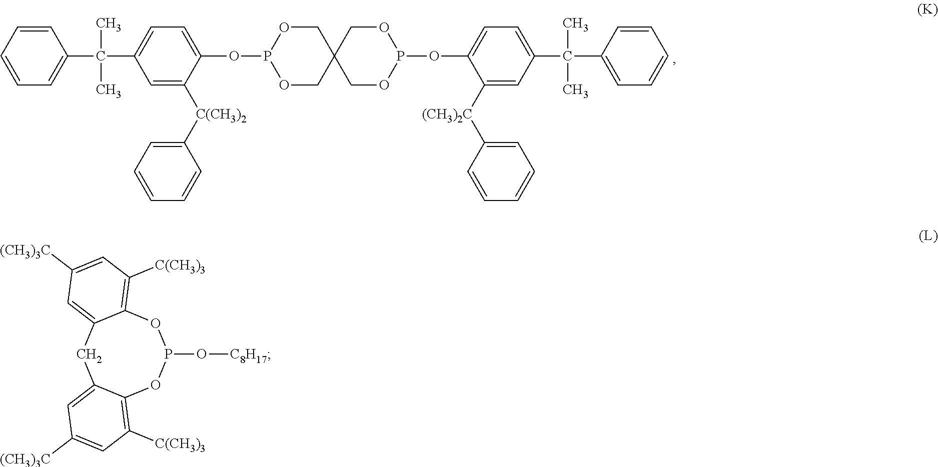
2-butyl-2-ethyl-1,3-propanediol 2,4,6-tri-tert-butylphenol phosphite,
bis(2,6-di-tert-butyl-4-methlphenyl) pentaerythritol diphosphite,
2-butyl-2-ethyl-1,3-propanediol 2,4-di-cumylphenol phosphite,
2-butyl-2-ethyl-1,3-propanediol 4-methyl-2,6-di-tert-butylphenol phosphite, or
bis(2,4,6-tri-tert-butyl-phenyl) pentaerythritol diphosphate.

14. The polymer composition of claim 12, wherein the phosphite or phosphonite comprises at least one of tris(2,4-di-tert-butylphenyl)phosphite (IRGAFOS™ 168), triphenyl phosphite, tris(4-nonylphenyl) phosphite, bis(2,4-dicumylphenyl)pentaerythritol diphosphite (DOVERPHOS™ S9228), or tetrakis(2,4-di-tert-butylphenyl)-4,4′-biphenylene-diphosphonite (IRGAFOS™ P-EPQ).

15. The polymer composition of claim 1, wherein the light stabilizer comprises a hindered amine light stabilizer (HALS) comprising at least one functional group according to Formula (II): 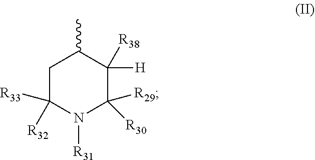
wherein:
R₃₁ is hydrogen, OH, C₁-C₂₀ hydrocarbyl, —CH₂CN, C₁-C₁₂ acyl, or C₁-C₁₈ alkoxy;
R₃₈ is hydrogen or C₁-C₈ hydrocarbyl; and
R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or
at least one functional group according to Formula (IIa): 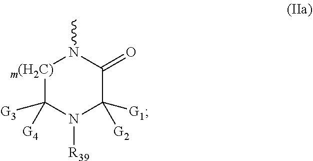
wherein:
m is an integer from 1 to 2;
R₃₉ is hydrogen, OH, C₁-C₂₀ hydrocarbyl, —CH₂CN, C₁-C₁₂ acyl, or C₁-C₁₈ alkoxy; and
G₁-G₄ are each independently C₁-C₂₀ hydrocarbyl.

16. The polymer composition of claim 15, wherein the hindered amine light stabilizer (HALS) comprises at least one of:
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanate;
1,2,2,6,6-pentamethylpiperidin-4-yl stearate;
1,2,2,6,6-pentamethylpiperidin-4-yl dodecanate;
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
tris(2,2,6,6-tetramethylpiperidin-4-yl) nitrilotriacetate;
4-stearyloxy-2,2,6,6-tetramethylpiperidine;
a condensate of N,N′-bis(2,2,6,6-tetramethylpiperidin-4-yl)hexamethylenediamine and 4-morpholino-2,6-dichloro-1,3,5-triazine (CYASORB™ UV-3346);
a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
a condensate of 2-chloro-4,6-bis(4-n-butylamino-1,2,2,6,6-pentamethylpiperidyl)-1,3,5-triazine and 1,2-bis-(3-aminopropylamino)ethane;
a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);
a mixture of 4-hexadecyloxy- and 4-stearyloxy-2,2,6,6-tetramethylpiperidine (CYASORB™ UV-3853);
a mixture of 4-hexadecyloxy- and 4-stearyloxy-1,2,2,6,6-pentamethylpiperidine;
a condensate of N,N′-bis(2,2,6,6-tetramethylpiperidin-4-yl)hexamethylenediamine and 4-cyclohexylamino-2,6-dichloro-1,3,5-triazine;
a condensate of 1,2-bis(3-aminopropylamino)ethane, 2,4,6-trichloro-1,3,5-triazine, and 4-butylamino-2,2,6,6-tetramethylpiperidine;
a condensate of N,N′-bis(2,2,6,6-tetramethylpiperidin-4-yl)hexamethylenediamine and 4-cyclohexylamino-2,6-dichloro-1,3,5-triazine;
tetrakis(2,2,6,6-tetramethylpiperidin-4-yl)-1,2,3,4-butanetetracarboxylate;
tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidinyl-4-yl tridecyl ester;
1,2,3,4-butanetetracarboxylic acid, 1,2,2,6,6-pentamethylpiperidin-4-yltridecyl ester;
formamide, N,N′-1,6-hexanediylbis[N-(2,2,6,6-tetramethylpiperidin-4-yl) (UVINUL™ 4050);
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371;
N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200);
TINUVIN™ XT-850/XT-855); or
N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

17. The polymer composition of claim 1, where the light stabilizer comprises a UV absorber that comprises at least one 2-(2′-hydroxyphenyl-s-triazine, 2-hydroxybenzophenone, 2-(2′-hydroxyphenyl)benzotriazole, or benzoxazinone.

18. The polymer composition of claim 17, wherein the light stabilizer comprises at least one 2-(2′-hydroxyphenyl)-s-triazine according to Formula (I): 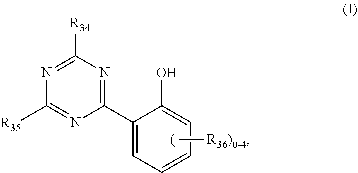
wherein each of R₃₄ and R₃₅ is independently a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl,
wherein the C₆-C₁₀ aryl group is optionally substituted at from 1 to 3 substitutable positions with at least one of OH, halogen, C₁-C₁₂ alkyl, C₁-C₁₂ alkoxy,C₁-₁₂ alkoxyester, C₂-₁₂ alkanoyl, or phenyl, wherein the phenyl is optionally substituted at from 1 to 3 substitutable positions with at least one of OH, halogen,C₁-₁₂ alkyl,C₁-₁₂ alkoxy,C₁-₁₂ alkoxyester, or C₂-₁₂ alkanoyl; and
each R₃₆ is independently OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

19. The polymer composition of claim 18, wherein the 2-(2′-hydroxyphenyl)-s-triazine comprises at least one of:
4,6-diphenyl-2-(4-hexyloxy-2-hydroxyphenyl)-s-triazine (TINUVIN™ 1577),
4,6-bis-(2,4-dimethylphenyl)-2-(2-hydroxy-4-octyloxyphenyl)-s-triazine (CYASORB™ 1164),
2,4-bis[2-hydroxy-4-(2-hydroxy-4-(2-hydroxyethoxy)phenyl]-6-(2,4-dimethylphenyl)-s-triazine,
mixture of 4,6-bis(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),
4,6-bis(2,4-dimethylphenyl)-2-(2-hydroxy-4(3-(2-ethylhexyloxy)-2-hydroxypropoxy)-phenyl)-s-triazine (TINUVIN™ 405),
4,6-bis(2,4-dimethylphenyl)-2-(2-hydroxy-4(3-(2-ethylhexyloxy)-2-hydroxypropoxy)-phenyl)-s-triazine,
2,4-bis(2,4-dimethylphenyl)-6-[2-hydroxy-4-[(octyloxycarbonyl)ethylideneoxy]phenyl]-s-triazine (TINUVIN™ 479),
2,4-bis(4-biphenylyl)-6-[2-hydroxy-4-[(octyloxycarbonyl)ethylideneoxy]phenyl]-s-triazine,
2,4-bis(4-biphenylyl)-6-[2-hydroxy-4-(2-ethylhexyloxy)phenyl]-s-triazine (TINUVIN™ 1600),
2,4-bis(2-hydroxy-4-butyloxyphenyl)-6-(2,4-bis-butyloxyphenyl)-s-triazine (TRIAZINE™ 460),
2,4,6-tris[2-hydroxy-4-(3-sec-butyloxy-2-hydroxypropyloxy)-phenyl]-s-triazine, or
2,4,6-tris[2-hydroxy-4-[(octyloxycarbonyl)ethylideneoxy]phenyl]-s-triazine (TINUVIN™ 477).

20. The polymer composition of claim 17, wherein the light stabilizer comprises a 2-hydroxybenzophenone that comprises at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-531), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

21. The polymer composition of claim 17, wherein the light stabilizer comprises a 2-(2′-hydroxyphenyl)benzotriazole that comprises at least one of 2-(2′-hydroxy-5′-methylphenyl)benzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVIN™ 1130), 2-[122′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, or 2-(5′-tert-butyl-2′-hydroxyphenyl)benzotriazole.

22. The polymer composition of claim 17, wherein the light stabilizer comprises a benzoxazinone that comprises at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p-nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-O-methoxyphenyl-3,1-benzoxazin-4-one, 2-cyclohexyl-3,1-benzoxazin-4-one, 2p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6-or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

23. The polymer composition of claim 1, wherein the light stabilizer comprises a hindered benzoate according to Formula (VI): 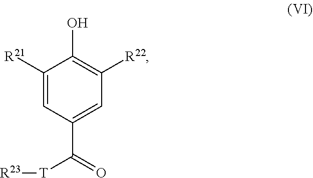
wherein:
each of R²¹ and R²² is independently a C₁₋C₁₂ alkyl;
T is O or NR²⁴, wherein R²⁴ is H or a C₁-C₃₀ hydrocarbyl; and
R²³ is H or a C₁-C₃₀ hydrocarbyl.

24. The polymer composition of claim 23, wherein the hindered benzoate comprises at least one of 2,4-di-tert-butylphenyl 3,5-di-tert-butyl-4-hydroxybenzoate (TINUVIN™ 120), hexadecyl 3,5-di-tert-butyl-4-hydroxybenzoate (CYASORB™ UV-2908), octadecyl 3,5-di-tert-butyl-4-hydroxybenzoate, octyl 3,5-di-tert-butyl-4-hydroxybenzoate, decyl 3,5-di-tert-butyl-4-hydroxybenzoate, dodecyl 3,5-di-tert-butyl-4-hydroxybenzoate, tetradecyl 3,5-di-tert-butyl-4-hydroxybenzoate, behenylyl 3,5-di-tert-butyl-4-hydroxybenzoate, 2-methyl-4,6-di-tert-butylphenyl 3,5-di-tert-butyl-4-hydroxybenzoate, or butyl 3-[3-tert-butyl-4-(3,5-di-tert-butyl-4-hydroxybenzoyloxy)phenyl]propionate.

25. The polymer composition of claim 1, further comprising a thiosynergist that comprises at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

26. The polymer composition of claim 1, further comprising an inorganic compound that comprises at least one of titanium dioxide, barium sulfate, zinc oxide, or cerium(IV) oxide.

27. The polymer composition of claim 1, wherein the polymer composition is free of barium compounds.

28. A stabilized polymeric article resistant to discoloration, cracking, and/or crazing upon exposure to UV-C (190-280 nm) light comprising the polymer composition as defined by claim 1.

29. The stabilized polymeric article of claim 28, wherein at least one of reduced discoloration, cracking, or crazing upon exposure to UV-C light is associated with the use of the light stabilizer in combination with the antioxidant compared to the antioxidant in the absence of the light stabilizer.

30. A method of making the stabilized polymeric article of claim 28 comprising:
adding to the organic polymeric material a stabilizer composition comprising:
an antioxidant selected from the group consisting of hindered phenols, phosphites and phosphonites, and mixtures thereof; and
a light stabilizer selected from the group consisting of hindered amine light stabilizers (HALS), UV absorbers (UVA), hindered benzoates, and mixtures thereof; and
shaping the organic polymeric material containing the stabilizer composition into the stabilized polymeric article.

31. A method of stabilizing an organic polymeric material against the deleterious effects of UV-C (190-280 nm) light, the method comprising adding to the organic polymeric material a stabilizer composition comprising:
an antioxidant selected from the group consisting of hindered phenols, phosphites and phosphonites, and mixtures thereof; and
a light stabilizer selected from the group consisting of hindered amine light stabilizers (HALS), UV absorbers (UVA), hindered benzoates, and mixtures thereof;
wherein at least one of reduced discoloration or reduced cracking or crazing upon exposure to UV-C light is associated with the use of the light stabilizer in combination with the antioxidant compared to the antioxidant in the absence of the light stabilizer.

32. The method of claim 31, wherein the total amount of antioxidant is from 0.001 to 5.0% by weight and the total amount of light stabilizer is from 0.01 to 2.0% by weight, both based on the total weight of the polymer composition.
